(19) United States
(12) Patent Application Publication
(10) Pub. No.: US 2006/0282302 A1
(43) Pub. Date: Dec. 14, 2006

(54) System and method for managing healthcare work flow

(76) Inventor: Anwar Hussain, Syosset, NY (US)

Correspondence Address: GREENBERG TRAURIG, LLP, 1900 UNIVERSITY AVENUE, FIFTH FLOOR, EAST PALO ALTO, CA, 94303, US

(21) Appl. No.: 11/413,930

(22) Filed: Apr. 28, 2006

Related U.S. Application Data
(60) Provisional application No. 60/675,783, filed on Apr. 28, 2005.
(60) Provisional application No. 60/675,784, filed on Apr. 28, 2005.
(60) Provisional application No. 60/707,597, filed on Aug. 12, 2005.

(51) Int. Cl. G06F 15/02; G06Q 10/00

(52) U.S. Cl. 705/9; 705/2

(57) ABSTRACT

A system and method for managing tasks and workflow in a complex environment such as a healthcare unit are described. The architecture of the inventive system includes core components and peripheral components that interact with each primarily through an interfacing event framework application within the core system. In addition to the event framework, the core system comprises a collaborative task platform and an intelligence application. The peripheral components include input devices for users, a system applications server, an integration server, person and asset tracking tags, a database server, and a knowledge base. The system manages workflow through a task-based orientation, and making use of task-based process mapping. Tasks may be created, including unstructured tasks, tasks may further be monitored, shared, transferred, and completed. The process may be envisioned as circular feedback loop including task management, metrics tracking, and real time process feedback. The task is a unit of transaction and central to system-based calculations which can measure return on investment that may, for example, include shorter length of stay in an emergency room, a decrease in medical errors, and an increase in revenue.

### RELATED APPLICATIONS

The present application claims priority from a first provisional application filed Apr. 28, 2005 under Ser. No. 60/675,783, entitled “Design of Metric-Based Information Systems”, a second provisional application filed Apr. 28, 2005 under Ser. No. 60/675,784, entitled “Design of an Adaptive User Interface”, and a third provisional application filed Aug. 12, 2005 under Ser. No. 60/707,597, entitled “Design of Software User Interface Icon to Monitor Patient Flow in Health-Care Settings”, each of which is incorporated herein by reference in its entirety.

### FIELD OF THE INVENTION

The present invention relates to a task management system for monitoring and optimizing workflow by healthcare providers in healthcare units, such as emergency rooms, large clinics, and hospitals.

### BACKGROUND OF THE INVENTION

The delivery of modern healthcare is a complex process involving the individual healthcare professionals working within complex multi-departmental health care units, who require medical information from global sources, local information from the community and from within the healthcare unit, and patient-specific information from electronic records as well as immediate information from person to person communication. In addition to requiring information, healthcare professionals have to be able to act, to guide patients and tasks within their unit in a rational manner, which ultimately provides optimal outcomes for patients individually, and the patient population, collectively.

A complex array of electronic systems have been developed for specific needs within the healthcare unit, and other systems, developed for more general business needs have been adapted for use in the healthcare unit. Many of these systems are well established, can be considered legacy in nature, and provide a formidable barrier to disruptive systems. The electronic medical record (EMR), for example, is a well established system that is a direct descendant of paper medical records. Use of paper medical records is still very prevalent; its replacement by EMRs may be impeded by constraints in facilities and budgets, but to the extent that it has been adapted, the success comes from its conceptual similarity to the paper system, and to its non-disruptive nature.

The tying together of legacy systems, and their collective integration with modern databases, poses a considerable challenge to information technology solutions, as many purposes need to be served. In addition to the delivery of healthcare per se, healthcare units are looking for solutions to practical aspects of their operation, including accounting and billing, distribution of personnel, tracking inventory and movement of equipment, etc. From many perspectives, the currency of healthcare unit operations are discrete medical tasks that collectively form workflow within the healthcare unit. Physicians and nurses think in terms of tasks they need to initiate, carryout, or complete. Patient movement through the healthcare unit is largely defined in terms of the tasks associated with their care. Billing is, to a major degree, linked to tasks which require the time and attention of healthcare professionals, and the utilization of equipment and supplies.

Medical tasks thus may represent an organizing principle that would be central to a network-based system that integrates legacy electronic systems and global databases in such a way as to manage workflow in a healthcare unit. Tasks, however, are highly individualized according to local particulars and to individual habits of healthcare providers. Tasks, further, may be multi-step in nature, are permeated with variables such as serial or parallel track options, and are subject to constraints that may either be institutional or instant and situational. Commercial systems that attempt to regularize, codify, or standardize the definition of tasks thus may founder for technical reasons, but more commonly first encounter resistance from healthcare professionals who cannot surrender the individuality of their medical perspective or their understanding of the particulars of the healthcare unit within they are working.

Another challenge facing a workflow management system in a healthcare unit is that of elevating the functionality of the system beyond the retrieval and distribution of information that is static in nature. The National Library of Medicine, for example, possesses a vast amount of information that is retrievable, but not, by itself, conformable or responsive to patient-, physician-, or local specifics. Similarly, static information about personnel, or equipment, or material inventory, is of little use to the immediate management of medical tasks unless the information is of a real time nature. Medical tasks and the composite work flow, thus, by their nature, are transactional, involving the simultaneous crediting of a resource toward a task as well as the debit represented by the removal of that same resource from the healthcare unit for application to another task.

Related to the transactional nature of workflow is the concept of return on investment (ROI) as a test of efficacy of a workflow management system. If such a networked workflow management system within a healthcare unit fulfills its mission of increasing efficiency, by whatever metric, then such metric should demonstrably improve. Metrics of interest include measures of clinical outcomes, minimization of medical errors, healthcare unit organizational efficiency, and institutional financial gain. To date, no system of workflow management known to applicants has shown such a return on the investment required to implement it. There is thus a need for improved workflow management systems in the healthcare unit, systems that are non-disruptive of legacy systems, which offer flexibility and user-friendly intuitive accommodation to the medical perspective of healthcare professionals, and which provide a real-time capability that supports the flow of tasks transactionally in such a way as to optimize the operation of healthcare units.

### SUMMARY

A system and method for managing workflow is provided, workflow comprising the aggregate of many tasks. The system is particularly adapted to managing tasks and workflow within a healthcare unit, such as an emergency room or a hospital. The system is task-centric and utilizes task-based mapping for guiding tasks toward an path this is resource-efficient and medically optimal.

The system comprises architecture comprises a core system and a peripheral system. The core system includes an event framework application, a collaborative task platform, in communication with the event framework application, and an intelligence application, in communication with the event framework application. The peripheral system comprises one or more client devices, a system applications server in communication with the one or more client devices and the event framework application, an integration server in communication with one or more legacy applications and the event framework application, a plurality of locational tracking tags in communication with the event framework application, a database server in communication with the event framework application, and one or more knowledge bases in simultaneous communication with the database server.

The event framework application of the core system comprises an event and message transport layer that serves as the major interface between the collaborative task platform and the intelligence application of the core system, as well as the major interface between the system as a whole, and the outside world. the collaborative task platform comprises functions that create, monitor, support, complete, and transfer tasks. The intelligence application comprises functional components agents, metrics, and rules.

The client devices of the peripheral system may include handheld PDAs, tablet PC, laptop computer, and desktop computer. The systems applications server may include enabling applications such as AJAX, JSP, XMPP, and VoIP. The systems applications server may further comprise functional applications such as department specific applications, task manager, reporting analytics, and documentation manager.

The legacy applications in communication with the integration server may include application such as ADT, EMR, LIMS, and PACS. The locational tracking tags associated with users, equipment, and material within a healthcare unit are typically RFID chips.

The databases in communication with the database sever include those focused on patient state data, resource state data, and work flow state data. The patient state data include typically include data on vital signs, medications, procedures, and subjective data. The resource data include data on user preferences, laboratory services, transport data, and department data. The the workflow data include data focused on task queing, task filtering, task sorting, agents, tasks, and metering.

A method of managing workflow is also presented, which utilizes the system architecture as described. Users interact with the system by way of entering data into the system by way of client hardware devices, typically mobile devices, but including desktop computers as well. Entering data may be directed toward infrastructural and asset maintenance and it may also be directly more specifically toward managing a task. Task related data entry includes defining a task, the task comprising one or more subtasks, initiating the task, monitoring the task, modifying the task, sharing the task, and completing the task. Tasks may either be structured, as they would be by a predetermined menu of choices, or they may be unstructured. As tasks become multiple and coincident in a work place setting, such as a healthcare unit, the managing of aggregate tasks assumes a larger encompassing workflow management dimension.

The managing of workflow by embodiments of the invention results in a more efficient workflow, the more efficient workflow being demonstrable by an increased return on investment. Such increased return on investment pertains to gains realized by the investment represent in the purchase and maintenance of the system, as well as training and usage time by users. Examples of such a return on investment include, by way of example, a shorter length of stay by a patient in a healthcare unit, a decrease in medical errors, and an increase in revenue for the healthcare unit.

### BRIEF DESCRIPTION OF FIGURES

FIG. 1 is a simple schematic depicting task optimization.

FIG. 2 is a schematic depicting the optimization of a series of tasks.

FIG. 3 is a block diagram showing a linear but bidirectional representation of task management and architecture of the system.

FIG. 4 represents the task management system as a circular process, cycling through three processes.

FIG. 5 is a table that provides an overview of a metrics analysis of a patient's length of stay in an emergency department.

FIG. 6 is a simplified flow diagram of the conventional workflow path that ensues as a patient enters an emergency department.

FIG. 7 depicts a conventional physical workflow path overlaying an emergency department floor plan.

FIG. 8 depicts a physical workflow path, as optimized by an embodiment of the inventive system, overlaying an emergency department floor plan.

FIG. 9 isolates the physical workflow paths of FIGS. 7 and 8, and displays them side by side.

FIG. 10 is a schematic of the core architecture of an embodiment of the inventive workflow management system.

FIG. 11 is a schematic of the combined core and peripheral architecture of an embodiment of the inventive workflow management system.

FIG. 12 is a schematic of an embodiment of the inventive workflow management system that focuses on the centrality of the event and message transport layer of the event framework of the core architecture.

FIG. 13 is a schematic of the knowledge base, depicting patient state, resource state, and workflow state.

FIG. 14 is a schematic of the basic components and processes of an embodiment of the inventive adaptive user interface.

FIG. 15 is a schematic that depicts an example of the operation of an embodiment of the adaptive user interface on the occasion of a heart attack patient entering an emergency department.

FIG. 16 is a representation of search patterns undertaken for presentation of data on an embodiment of the inventive adaptive user interface.

FIG. 17 depicts data that have been appropriately filtered and delivered to an embodiment of the adaptive user interface.

FIG. 18 depicts an embodiment of a graphic user interface icon.

### DETAILED DESCRIPTION OF THE INVENTION

General Description of a Workflow Management System

Aspects and exemplary embodiments of an inventive system for the management of workflow in a healthcare environment will be broadly described in terms of its capabilities with regard to task management functions, task optimization, the role of task management in patient safety, and system architecture, as detailed in subsections below. The inventive task management system is highly transactional (sharing, transfer, synthesis of raw patient data), task-centric, metric-focused, and enabled by robust, synchronous communication among users. By comparison, for example, electronic medical record (EMR) systems are raw data-centric and static. They comprise a repository of patient information that is updateable, but neither analytical nor integrated with other information systems, and thus not self-enabled to support clinical tasks in real time. Such enablement is provided by the harnessing of the EMR data within the structure of the inventive workflow management system.

Another significant feature of the system described herein is that it respects the workflow as it has evolved personally, for individual users, and for the healthcare unit as a whole. As such, the system is neither disruptive of ongoing healthcare unit operations nor confining of the users, rather, it integrates into existing habits and operations without disruption. The inventive task-centric management system complements the EMR to create a robust information technology (IT) system that solves major needs that EMRs alone do not provide for, such as: (1) a user-flexibility without which users do not adopt or comply, and (2) the delivery of a true and measurable return on investment (ROI). The return on investment

The inventive task-based system serves both healthcare professional users as well as the healthcare unit within which they work, by focusing on enabling, tracking, and optimizing the logistics of patient care. By “task-based” or “task-centric” it is meant that the data of the system are closely associated with medical tasks; this follows from a theoretical perspective that sees the medical tasks as the central currency and subject of transactions in the healthcare unit. These perspectives contrast with those of conventional workflow management systems that are focused on billing, or are oriented toward the bureaucratic hierarchy of a healthcare organization, informed as they are by established business and organizational models. According to one aspect of the inventive workflow management system, the system is able to measure performance within the healthcare unit it serves, and thereby provide ROI data on its own performance, particularly as the system accumulates data, and particularly as changes in the operation of the healthcare unit are implemented. Embodiments of the invention can be understood as a task management and optimization “shell” that draws patient data from other systems and is applicable to an entire hospital, an outpatient clinic market, or any other healthcare facility. The invention enables users to manage and optimize their own day-to-day workflow; this provides benefits to the healthcare unit in general, but more specifically, it improves important healthcare metrics of clinical and financial performance.

Certain aspects of the invention may be referred to variously as a task management systems or workflow management systems, depending on context. More generally, in practice, many tasks are managed by the system and users simultaneously. As the number of aggregate coinciding tasks increases, it becomes increasingly appropriate to describe the system as one that manages a “workflow”, “work” being a broader term, one that embraces “task”. Users of embodiments of the inventive system typically are healthcare professionals such as nurses, physicians, and technical and administrative staff working in a healthcare unit environment. In embodiments of this invention, a “health care unit” may vary in form, size, and position within an organizational hierarchy. These various forms of “health care unit” to which this invention may apply have in common the possession of an electronic network through which the health care professionals within the unit are operatively connected. A health care unit may be a subunit of a larger health care unit. A “health care unit” may consist of a single person (a health care worker) working alone (the person nevertheless connected to a network); the person may be working within a medical facility, or working alone, in the field. A “health care unit” may further include, for example, an emergency room or a clinic, such unit having a multiplicity of health care workers working therein. Such a health care unit may be a stand-alone facility, or it may be a subunit within a larger institution, such as a hospital or medical center. A “health care unit” may further be a hospital or a medical center, as whole, which comprises a multiplicity of associated working health care subunits. A “health care unit” may further include any combined set of subunit clinics or hospitals that are not physically co-located, but which function together as a unit by way of an electronic network.

Task Management Functions

According to aspects of some embodiments of the inventive system, a system is designed to manage the full range and complexity of tasks of the full healthcare provider team (physicians, nurses, and other technical and professional staff) that is responsible for carrying out tasks to treat patients. (In this description, “physician” is used throughout, although “doctor” is an equivalent term.) These tasks are sometimes simple, but typically complex. Tasks may involve either single steps or multiple steps that are carried out by a single individual, multiple individuals, and/or multiple groups. Tasks are often “structured” (already well-defined and repeated often, e.g., ordering of an x-ray) but they may also be “unstructured”, as in ad hoc tasks that are created as needed (e.g., contacting a family member of the patient). Tasks may be linked (e.g., one must occur before another is started) or they may be independent of one another.

Tasks represent an abstraction of multiple steps and are the units that the user mentally represents and uses in patient care. An example of a task is that of a physician writing a prescription for a patient; the steps involved, for example, may comprise the following:
1. Select a class of drugs (e.g. antibiotic),
2. Select an individual drug within class (e.g. penicillin),
3. Find a generic version, if available, to reduce costs (e.g. generic penicillin),
4. Confirm if drug is appropriate for problem (look up if drug is used for such infections),
5. Find dosing for patient (ranges exist for all drugs),
6. Decide on length of treatment (stronger infections require longer therapy),
7. Check for patient allergy to the selected medication,
8. Check if this drug interacts with other drugs patient is on (some drugs commonly interact with other drugs and may lead to negative side effects, and sometimes death),
9. Find another drug if patient allergic or if drug interacts with existing treatment,
10. Adjust dosing if pediatric patient (children dosing is set by weight in kilograms),
11. Adjust dosing if elderly patient (elderly patients require lower doses because they older patients cannot excrete drugs as quickly as younger patients),
12. Write the prescription (dose, route, length of therapy, drug name, patient name, and signature required),
13. Give the prescription to the patient and/or fax to pharmacy, and
14. Record the prescription information in medical record.

Most of these general steps within a task tend to repeat from one patient to another, forming patterns that are recognized by embodiments of the inventive task management system. There are other patterns of note: individual physicians and individual departments in a hospital will use one class of drugs more often than another. For example, a dermatology department will use skin medications much more often than other departments. Other drug classes are commonly used across different departments; antibiotic and pain drug classes, for example, are often used with commonality across all departments within a healthcare organization. Individual physicians typically become accustomed to using a subset of available or appropriate drugs, and may habitually use the same medication for treating infections, or pain. These are patterns of task-associated behavior that the inventive workflow management system may identify, remember, and elevate in terms of default choices or rank within a list of options. Similarly, the inventive system may be configured to identify frequently occurring patterns of steps within tasks, and provide the option of making them automatic.

Existing information systems such as the electronic medical record (EMR) are useful databases of patient information, but do not structure patient data nor provide tools to allow users to easily manage patient tasks. Tasks represent an abstraction of multiple steps and are the units that the user mentally represents and uses in patient care. For example, effective task management generally requires robust synchronous communications among the provider team. The EMR does not provide such a tool, and can be understood as “infrastructure” technology that should have a task-based dynamic complement, as exemplified by aspects of the present invention, in order to effect control of workflow.

Task management typically involves the ability of a team of providers to coordinate the completion of multiple simultaneous patient care steps. There should be synchronous, multi-modal communications systems; and the ability to track patients through their process of undergoing those tasks. Radio frequency identification (RFID) is one technology that may be used as a locational tagging system to track patients as well as equipment and material. Various embodiments of the inventive task management platform provide certain specific capabilities; these include task creation, task monitoring queuing, task modification, task sharing, and task completion, each of which is described further in sections below.

Task Creation and Initiation

Managing tasks through the use of the inventive workflow management system is typically effected by users entering data into a client device. The system provides users the ability to initiate tasks that the user defines either by selecting from a set of already defined tasks or by creating a task de novo. A task, upon initiation, is deployed into the system as unit that is subject to various transactions that follow. Task creation is supported by merging ontologies of symptoms and medications, as is supported, for example by the unified medical language system (UMLS). The ability to create tasks is an important aspect of the inventive task management system in that it frees the user of the constraint of having to draw only from a list of pre-defined tasks. The use of the task as the currency of workflow detaches the system from the constraints represented by a billing focus or by hospital management hierarchy, the ability of the system to track, sort, filter, and modify tasks in real time, as described below, and the ability of users to engage the system from any location, all come together to provide a system that is fully dynamic.

A system user can create a new task and send it to another user to carry out the task. The task-creating and sending user can pick from a list of predetermined structured tasks or create a new (unstructured) task by describing and naming it in a text box. Notes may be attached to the task in order to provide more information to the receiver of the task. For example, the system may allows the task creator to create a voice or text file that is attached to the task. The task is sent to a radiologist who then listens to the voice file to find out any relevant complications that he would need to know about. The receiver of the step or task is able to access the specifics of the task (description) and is able to respond with task status information, that it is completed, pending or delayed. The receiver is able to communicate with the sender of the task in the midst of task performance (e.g. to ask for more specifics on what to do). Once finished with task, the receiver can “click” that the job is complete; this step automatically alerts the system the task is complete, and it may lead to more steps that are automated. For example, an alert to the sender may be sent to remind the person that the task is complete. Also, a second task may automatically begin due to the completion of this initial task. For example, an automatic request for a call to a specialist (e.g. cardiologist) may be started due to a procedure being completed (e.g. electro-cardiogram). Tasks may be sent to multiple receivers who all share in completing multiple steps of a single task. Each step must be completed (by either an individual or a group) in order for the system to recognize that a multi-stepped task is complete.

Task Monitoring/Tracking

According to other aspects of the invention, after a task is created and entered into the system, the sender can monitor the status or progress of the task in multiple formats. A timeline is one method of displaying how multiple tasks are progressing. The timeline may be expanded further to display how each task is progressing as a part of a more aggregate timeline of tasks. Information displayed in monitoring the task may variously include the person or persons responsible for completing the task, patient's name and location, and lists of total tasks for the patient (whether completed, pending, or delayed). When multiple tasks across multiple patients are ongoing, monitoring involves an aggregate of multiple task timelines. At this level the user could get data that focuses on displaying bottlenecks. The user is able to respond to bottlenecks by communicating (with a single tap or click) with the person or persons responsible for task or tasks that are causing the bottlenecks. Tasks can be sorted by type automatically by the system in order to assess bottlenecks more easily. For example, all open radiology tests can be displayed as a queue, and average time to complete tasks in radiology.

Task Sorting, Filtering, and Queuing

Tasks that are incomplete can be sorted or filtered by different characteristics. For example, all open tasks can be sorted by “length-of-stay” (i.e. length of time the patient has been in the department for treatment, abbreviated “LOS”), by “acuity” (i.e. a term used to rate how sick a patient is when presenting to the department), and by proximity to the user (i.e. the user can complete tasks that are physically located close by). The sorting capability allows users to manage their individual workflow.

A creator of tasks (e.g. a physician) can also determine which tasks have priority over others within the list of tasks associated with a patients. For example, the physician may judge that the x-ray is a higher priority task than getting blood for clinical laboratory tests. Setting priorities allows the receiver of tasks to prioritize their work; furthermore, the system can also automate prioritization once algorithms are employed. In this scenario, the list for receivers of tasks can automatically be ordered by priority.

In some instances, tasks that are ordered will be carried out in a parallel manner (i.e. tasks are independent of each other). In other instances, tasks are set in a serial manner—one task's completion is required to start the next task. For example, typical medical practice would recommend doing an x-ray first (to look for the reason for abdominal pain) as a less expensive test before ordering a more expensive test such as a CT scan. In still other instances, within a list of tasks there is a mix of tasks that may be undertaken in a parallel manner, and other tasks that need to be undertaken in a serial manner.

Filtering and sorting is a feature of task management that is closely associated with the adaptive user interface, and is discussed further in that section, below. Briefly, there are constraints on both cognitive capacity on the part of users, and on the physical space afforded by a graphic user interface, whether it's measured in terms of square inches or pixels. Intelligent filtering and sorting enables optimal use of the physical or visual space through which the user interacts with the system, as well as enabling optimal use of the attention and understanding capacity.

Task Modification

An ordered task can be modified, for example, it may be cancelled, changed, or steps added or subtracted. For example, in ordering a new drug for a patient, the sender may ask the receiver to ask for any past reactions to a drug (the nurse would be requested to query the patient) before the order for the drug is completed. Once the nurse confirms that the patient has had no negative reaction in the past, the next step in the drug order is added (i.e. dosing and route of administration for that drug).

Task Sharing

Tasks are typically multi-stepped; an example is provided by repairing a laceration. A physician would act as a sender, asking a nurse to prepare a laceration kit for a patient. Once the nurse completes preparation of the kit and enters that completion in the system, a message auto-populates the task list of the physician showing that that the laceration kit is ready for use on the patient. This minimizes down time in completing multi-stepped tasks.

Sharing of tasks can occur in other modes. A receiver of a task may be able to transfer the task to another receiver (with permission from the second receiver). For example, a nurse may ask another nurse to reduce his or her workload by taking on a few tasks. Also, when one physician finishes a work shift, he or she can transfer all or some patients (and associated tasks) to another physician who is just starting a work shift.

Task Completion

The receiver of a task can trigger completion of a task on a user interface. This act can auto-trigger other tasks or messaging. For example, an automatic page may be started for a specialist once a cat-scan is completed. The page also triggers an alert to the physician who was the original creator of the task. This alerts the physician that a specialist will likely call back regarding this patient. Completion of tasks must also update patient-specific timelines and aggregate timelines (i.e. bottlenecks).

Task Optimization Functions

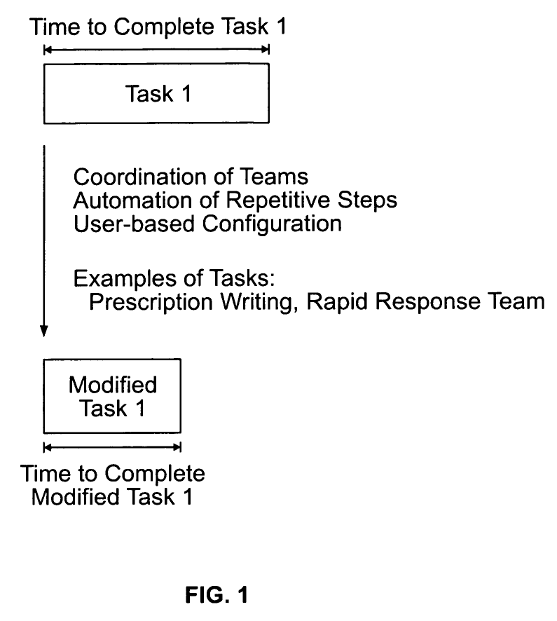

Both individual tasks and collections of tasks can be optimized. For an individual task, the time needed to complete multiple steps can be reduced by multiple mechanisms. By way of example, (1) automation of repetitive steps (e.g. automated adjustment of drug dosing for weight—a highly repetitive step), (2) coordination of the team (e.g. routing the right step in a multi-step task to the right person at the right time), and (3) routing important information to the decision-maker as soon as it is available are examples of how time to completion may be reduced for an individual task. Optimization of a single task by such exemplary approaches is depicted schematically in FIG. 1, whereby elapsed time between initiation and completion of a task, moving from left to right, is significantly reduced.

Tasks can be optimized in aggregate if they are seen as units of optimization. Optimization involves trying to directly tying tasks to specific healthcare metrics. Metrics are generally categorized into three categories: clinical, financial, and efficiency measures. Metrics, further, are generally understood in terms of a constraining factor, one which can be expressed as a denominator of a term, such as patients seen per physician per day; in this case, the constraint is physician x days. The use of metrics such as this, normalizing a quantity of medical result or service, provides a measure of return on investment to the healthcare unit. The investment, in this context, may be understood as investment of time and resource in the workflow management system, such time including the time users spend engaging the system, and resource including the money spent on purchasing and maintaining the system.

Examples of clinical metrics include door-to-drug time (i.e. the time it took to get a drug into a patient in need of such drug), and use of a beta-blocker after heart attacks (beta-blockers represent a class of drugs that has been proven to improve outcomes in heart attack patients). Examples of efficiency metrics include length-of-stay (how long the patient was in the department receiving treatment) and size of provider team/patient volume engaged on a given task (a proxy for how efficient the staff is in treating patients). Examples of financial metrics include total revenue and cost of treatment per patient, as well as avoidance of liabilities.

An operating perspective of the inventive workflow management system is that metrics are a function of specific tasks. In other words, metrics represent a measure of how optimally a set of tasks were completed. For example, revenue per patient is a function of a set of tasks that include carrying out patient treatment tasks and completion of all reimbursement tasks (i.e. to get paid for the treatment from the insurance company). Optimization of the revenue metric involves completing all tasks, doing them in the shortest amount of time (in order to get more patients done), and making sure that the physician and nurses documents all the right information in order to get complete reimbursement from insurance companies.

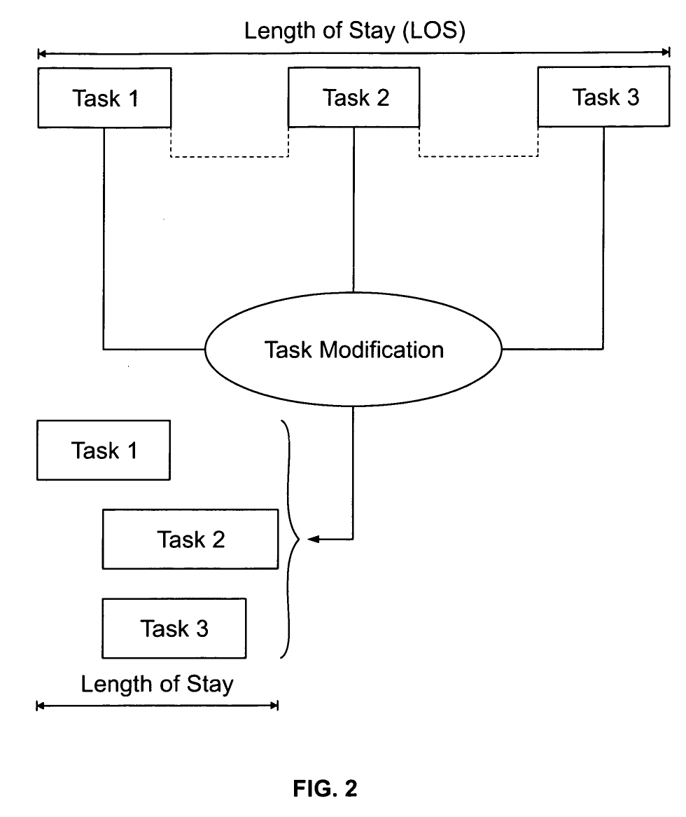

Multiple tasks can be optimized for the purpose of improving metrics. Because metrics are a function of tasks, the goal is to optimize the correct individual tasks and the correct combination of tasks in order to improve the metric of interest. A feature of the inventive system includes time-stamping of data entry, and retrospective analysis as a source for feedback. Reducing length-of-stay (LOS) in an emergency room is one specific goal that would be of interest. As discussed above, one can reduce the time required to complete individual tasks. In trying to optimize time to completing a set of tasks, multiple methods can be used. As a system understands (based on past experience) what each individual user (a nurse or a physician) does for a specific type of patient, it can provide specific decision support. For example, a system can assess the tasks that are done for pneumonia patients by one specific physician. The system may then provide customized decision support for that physician by suggesting removing a task or steps within a task, based on research identified by the inventive system, through its access to external databases, showing that such steps or complete tasks are not needed to treat pneumonia. Another mode of reducing the LOS is to minimize the unnecessary loss of time between tasks; embodiments of the inventive system may do this by automating task queue and displaying the right information to the right person (i.e. decision maker) as quickly as possible. Finally, tasks may be initiated in parallel rather than running them in a serial manner. Optimization of a multiple tasks associated with a single patient admitted to an emergency department by such exemplary approaches is depicted schematically in FIG. 2, whereby elapsed time between initiation and completion of multiple tasks, moving from left to right, is reduced by these various approaches, resulting in a significantly decreased length of stay.

Other metrics can also be broken down into specific set of tasks that can be optimized. As more data are collected by the system more complex metrics can be optimized. Complex metrics (such as cost per case of pneumonia) require the optimization of multiple and often seemingly unrelated tasks that would need more data to analyze completely. Further, rate-limiting tasks, or bottlenecks, can be improved in order to improve the LOS. For example, in an operating room the delay of one patient's care can cause long delays for other patients who are waiting. If a bottleneck is identified early, either as a chronic or typical circumstance, or as one that develops in the course of a day, more staff can be assigned to the bottleneck point to get those tasks completed in order to maintain or shrink the LOS.

Another example of metrics optimization is relevant when one is tracking long-term tasks that are not completed during one patient visit. For example, starting a blood pressure medication requires that task be monitored over a few weeks in order to see if the patient's blood pressure is responding to the medication. Response often takes weeks to assess for many drugs. Task management as provided by embodiments of the invention can also be helpful in this situation. First, a timeline may be generated that monitors variables of interest—in this case blood pressure, and pulse. Second, at each subsequent visit the system can automatically add specific questions to the patient's interview. For example, one such question would be, “are there any other drugs you have started since you started taking the new blood pressure medications?” This question probes the patient about any drugs that may be interacting with the blood pressure medication. The key point here is that starting a new medication is one long-term task that should be managed as such—it should include timelines, response to drug etc. Other such long-term tasks (i.e. patient interventions) exist commonly in patient care.

Improving Patient Safety and Contributing to Medical Knowledge Using Task Analysis

Patient safety is currently a large problem in the U.S. healthcare market. According to some studies medication errors are ranked as the number three killer of patients in the country. Since the Institute of Medicine study in the 1990s described the magnitude of this problem, very little has been accomplished to improve the situation. The difficulty lies in the complexity of the healthcare delivery process, having so many moving parts as it does. In order to even attempt to improve the problems a solution needs to conform to the actual processes of healthcare delivery, with all their attendant complexity and constant changing of form.

Embodiments of the present invention allow individuals and a group to create and manage their own tasks for patient care, and thereby provide a real-time, user-effected process map of healthcare delivery. Task-based process mapping is an approach embodied within aspects of the invention to capture the dynamic of a continuously changing environment through which tasks navigate. Even relatively standard processes inevitably change due to variation in the types of patients seen, the day of the week, size and composition of the provider team, and any number of other variables and circumstances. In one aspect of the invention, the task-based process map generated by embodiments of the invention provide a context within which the method of the invention plays out, i.e., it provides the context for task creation and initiation, task monitoring, task sorting, filtering, and queuing, task modifying, task sharing, and completing. Task-based mapping is appropriate for a multivariate environment in which tasks have been initiated by users toward an optimal conclusion, in which not all variables are under the control of users, but in which interventions may be effected by users during the trajectory of the task. The purpose of interventions is to respond to new conditions or information that occur during the passage of time, and modify either the tasks or the environment of the task, toward the end of achieving either the original concept of an optimal conclusion, or to formulate a new optimal conclusion and direct the task toward that new end. Once one has a task-based process map, there are interventions that can be brought in to help the team minimize the risk of errors from occurring.

Stated from a slightly different perspective, it may be said that the purpose of interventions is to minimize medical errors. A modern concept of medical errors acknowledges the level of resilience of medicine, as practiced in a modern healthcare unit. This resilience protects the patient against most errors. An aspect of medical practice is that of making appropriate medical decisions; decisions that are made that reflect a lack of the application of available knowledge may be termed medical error. One of the functions of the present invention is that of bringing medical knowledge to the decision process in a manner that facilitates the rendering of better decisions.

Many medical, administrative, or healthcare unit systemic errors, in fact, go undetected because of the aforementioned resilience of modern medical practice. Current practice, however, also has complexity, and at a certain level, it is the coincidence of multiple small errors from that complexity, which if occurring as a solo error would go undetected or without consequence, but which in coincident occurrence manifest as overt error. One of the functions of task-based mapping is to marshal data for appropriate analysis, such that both simple and coincident errors are prevented. Thus, an example of using a process map, as provided by embodiments of the invention is the application of modern methods of analysis, including, for example, probabilistic risk analyses (PRA), failure mode event analysis (FMEA) and root cause analyses (RCA) to data complied by the system. By use of these analytical methods, users can collect feedback on many events that can contribute to the ability to anticipate and predict with increased accuracy the risk of an adverse event (e.g. giving a drug to the wrong patient). As data within the inventive system grow over time, the system becomes increasingly capable of assessing real-time risk and providing decision support (e.g. warning of risks) to users. Finally, accumulated data can be mined within the system, retrospectively, by researchers for larger trends, integrated with existing types of data using meta-analysis, prepared for publication and rapid dissemination into the medical practice and policy development.

Another aspect of some embodiments of the inventive system is that of providing patient safety alerts. Such alerts may occur in response to a change in patient vital signs, or the inadvertent or ill-advised prescribing of a drug with which the patient has an adverse history, or which is contraindicated in view of the patient's present condition or other drugs the patient maybe taking. The implementation of this aspect of the invention draws on many aspects, including aspects of pattern recognition and the adaptive user interface.

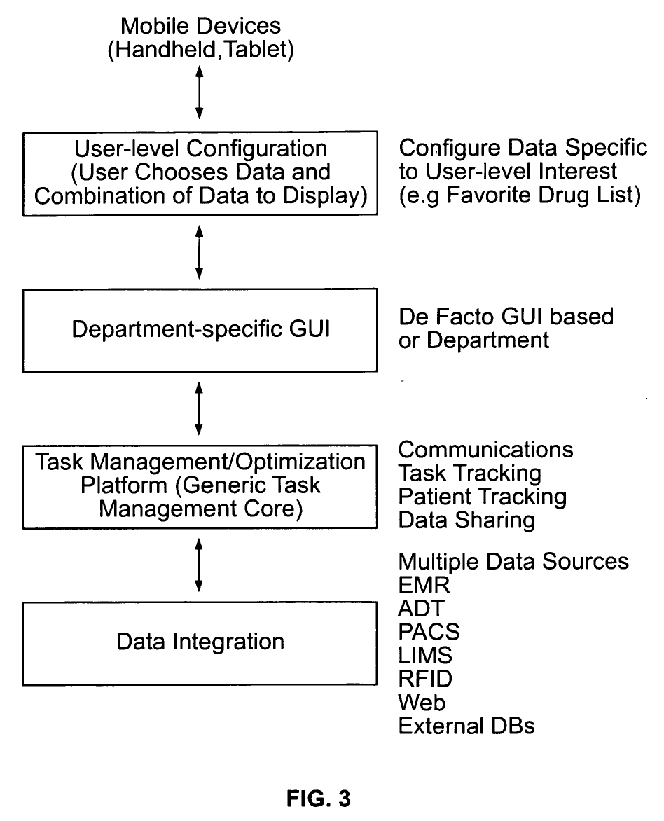

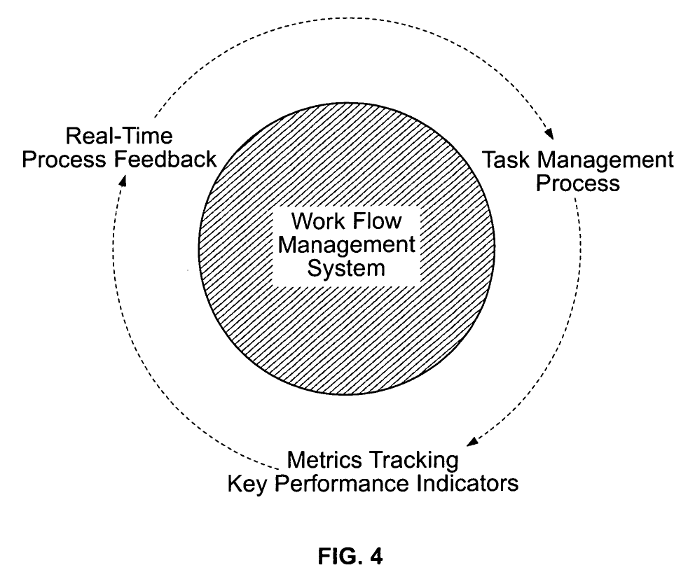

FIG. 3 depicts a schematic of the overall architecture of the workflow management system in functional terms. In even more abstract terms, the system can be depicted as a continuous feedback loop that improves the quality of workflow management, as depicted in FIG. 4, involving (1) management of tasks, (2) tracking of metrics associated with the tasks, and (3) realtime feedback on task management function that is exploited by the system toward the end of managing tasks more efficiently. Feedback requires intensive retrospective analysis, as provided by embodiments of the system, as well as time stamping of data entry.

### TASK MANAGEMENT EXAMPLE 1

### Length of Stay in an Emergency Department

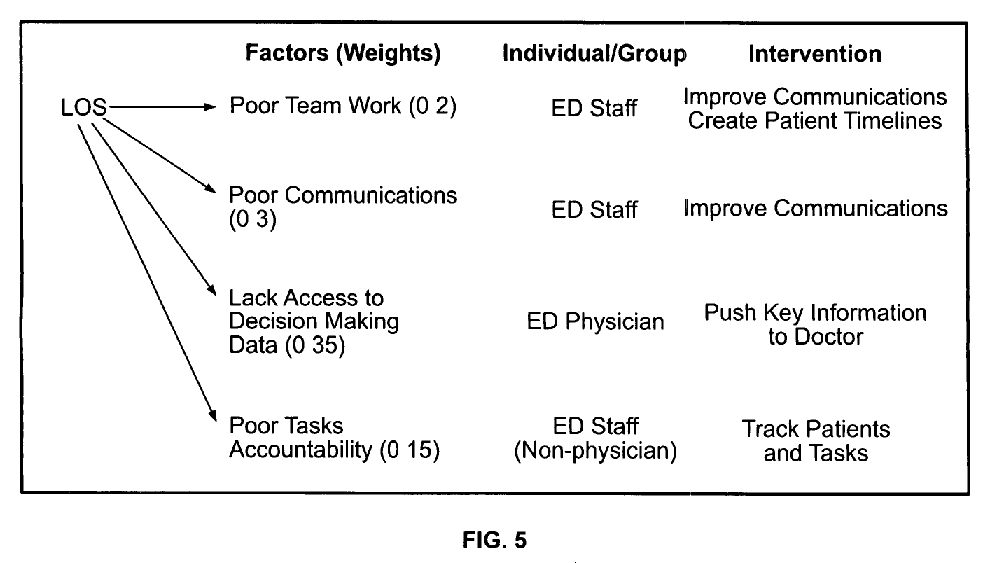

This example, depicted in FIG. 5, represents a simplified analysis of the metric, length-of-stay (LOS), for a patient visiting the emergency department (ED). A full analysis would involve multiple other factors, and more detailed work associated with the individuals involved and with the interventions, such as the following.
1. Improve communications: Create methods to improve communications both within the ED and outside the ED. Physicians would carry a multimodal handheld that provides the ability to instant message to all team members (e.g., nursing, triage, tech, registration, and other physicians) or call them if they have a phone extension. The handheld (e.g., Palm Treo) can also allow communications outside the ED, for example, to other physicians or to floors of the hospital, and to anyone outside the hospital.
2. Create patient timelines: Each patient can have a timeline that is shown on the handheld and on other computers. The timeline could delineate what needs to be done, how long the patient has been in the ED, who is responsible for the tasks, and how long it has been since the order was given by the physician to complete a specific task. This creates transparency of information and everyone is aware of who is responsible for what task (i.e. accountability) in order to get the patient treated. Reminder systems (about length of stay becoming too long, for example) can help people keep up efficiency.
3. Push key information to physician: currently the physician often wastes a lot of time looking for data (e.g. lab results, x-ray results). Instead of having the physician hunt for these results, methods can be created to have that information delivered to the physician. For example, lab results can be delivered in real-time to the handheld, and once the x-ray is complete the technician could instant message the physician that the ordered x-ray is available to be read.
4. Track patients and tasks: RFID technology can be used to track patients through out their visit. This technology can locate patients anywhere in the ED, but also allows one to understand how long a patient spent in a specific part o the ED. This information can provide data about bottlenecks and helps the department focus on improving such problems. Tasks can be monitored via timeline as described above.

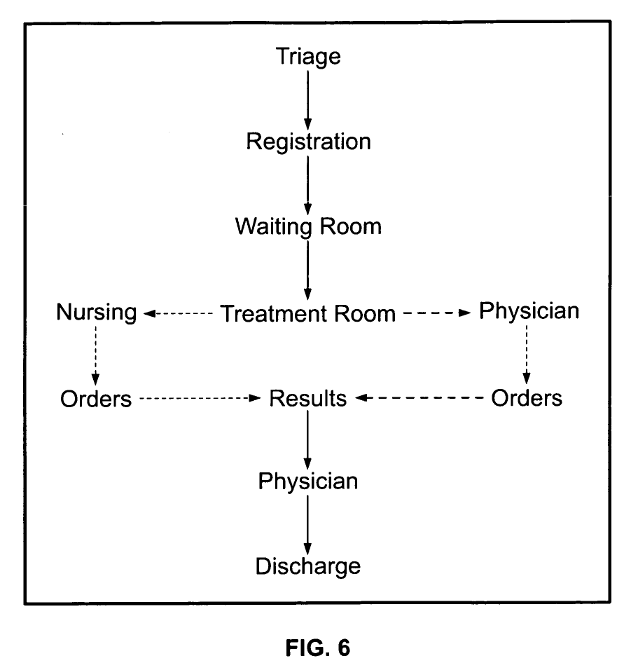

A case study is now outlined: first a conventional workflow path is outlines, and then a reconfigured workflow path, as provided by an embodiment of the inventive workflow management system. Currently, patients entering the ED follow a very linear path to treatment, as depicted in FIG. 6.
1. Triage: the patient is seen by an experienced triage nurse who elicits and records basic information about the problem and vital signs. The nurse then assigns an acuity score to the patient which reflects how severe the case is. This allows the rest of the staff to focus on those patients who need care quickly.
2. Registration: if the patient is not severely ill, he then goes to registration where a staff person elicits and records insurance information and other patient specific and demographic data.
3. Waiting room: the patient then waits in the waiting room (often up to 6-8 hours) until a treatment room opens up. The patient's paper chart usually stays up front with the patient until the patient gets inside the ED.
4. Treatment room: once inside the ED, the patient is assigned a bed or location for their stay.
5. Nursing: nursing usually sees the patient first and often times a nurse will perform basic tasks (e.g. blood draws or an x-ray).
6. Physician: the physician usually sees the patient after the nurse has seen the patient. The physician elicits and records more detailed information on the paper chart, and ask for additional orders.
7. Results: these are the results of the tests that the physician ordered. The patient usually is led to other areas of the ED if he needs some specific procedure (e.g. x-ray). Blood draws are usually done in the treatment room.
8. Physician: once the results are in, the physician studies them and decides on what to do for the patient. Most patients are discharged to their home with an intervention like a prescription and a recommendation that they follow up with their primary care physician.

In summary, the above delineated conventional approach is very linear approach and inefficient with regard to staff workflow. To decrease LOS (organizational metric), through the implementation of an embodiment of the inventive workflow management system, multiple interventions are instituted.
1. Triage: The nurse enters her data into a computer and this data is available to everyone (on a need to know basis) in the back of the ED. The ED physician can immediately send orders based on the initial data (treatment has started even without a treatment room). If the patient is severely ill the physician can go see the person in the front of the ED. The patient has an RFID tag placed on their wrist in order to track LOS and physical location in the ED.
2. Registration: Registration is mobile, and this person will follow the patient wherever he is (based on location by RFID). This cuts down significant time from LOS.
3. Waiting room: Orders are sent by the handheld to the nurse's user interface. The nurse can go up front to the waiting room and take the patient to a private area to draw samples for laboratory tests. The x-ray technician who also gets an order request on his user interface can then take the patient to radiology to get the x-ray. Each time the order is completed, the nurse and the technician note “completed” on the order they received (from the physician) on their user interface. This updates the patient timeline and the physician can monitor these steps by the handheld device.
   While waiting for the results of this patient, the physician can call a specialist on the handheld in order to discuss another more serious patient. The physician can also go see new patients or finish documentation on patients who are already discharged. Laboratory results on the patient come back directly to the handheld device (the physician does not need to go look for them repeatedly on a stationary desktop computer), and the x-ray technician will note on his screen that the x-ray is ready once it is completed. If the technician is taking too long the physician can call him by phone or instant message him about the holdup. The patient still does not have a treatment room but has already started treatment. LOS has dropped significantly as compared to the original linear approach.
4. Results: After the laboratory results and x-ray(s) are studied, the physician sees the patient for the first time (potentially in the waiting room if a room in the back has not opened up) and examines him in a private area. The physician provides the results of the orders to the patient and discharges the patient (another order) via handheld. This information is transmitted to all users, and the nurse can then prepare paperwork to send the patient home. The RFID tag on the patient is removed before he is sent home. LOS has shrunk significantly because of utilizing both the patient's and ED team's time more efficiently. Users can access aggregate data on bottlenecks (using RFID), which become subsequent targets for interventions.
   Note that the metric analysis will typically be more detailed than in this example. An object of this invention is to take a systems level approach to analyzing the hospital or department as an “organisms, consisting of individuals/teams, patients, and tasks necessary to improve specific outcomes. The organism is in flux and the IT system needs to take that into account and modify inputs as necessary in order to maintain or continue improvements. This approach can also be generalized into other departments of the hospital, clinic, etc. The approach is agnostic towards any specific technology—one only needs to borrow the best technology tools that fit a specific need to improve outcomes. It is a clear way to reduce the immense cost and improve the quality of the healthcare delivery system in the US and other countries. Finally, other professions with complicated decision-making processes, a heavy dependence on teamwork (e.g., a dentist) and an outcomes emphasis can also utilize this approach.

### TASK MANAGEMENT EXAMPLE 2

### Monetary Impact of Optimizing Workflow

Inefficient workflow in a healthcare unit is extremely costly in terms of the directly associated lost revenue and/or lost time that represents an opportunity loss. A midsize emergency department receives on the order of 35,000 visits per year. Based on that volume, and anticipating a reasonable estimate of the impact of the inventive task management system implemented into the emergency department, the following effects are anticipated:
1. A 15% increase in charge captures would yield $2.14 M in increased revenue.
2. A ⅔ reduction in the rate of patients leaving without being seen (currently ˜3%) would yield approximate $214,000 recovery.
3. A 10% reduction in the length of stay (currently ˜2.5 hr) would result in the freeing of nearly 9,000 employee hours.
4. A 50% reduction in post duty charting (currently ˜2.5 hr/patient) would result in the freeing of approximately 2,300 employee hours.

Thus, the implementation of an embodiment of the inventive workflow management system, and by operation of its methodology, a healthcare unit may expect a return on investment from such system and its operation, and such return on investment may, inter alia, increase the rate of accrual of revenue earned by the healthcare unit.

### TASK MANAGEMENT EXAMPLE 3

### Graphic Depiction of Optimizing Workflow

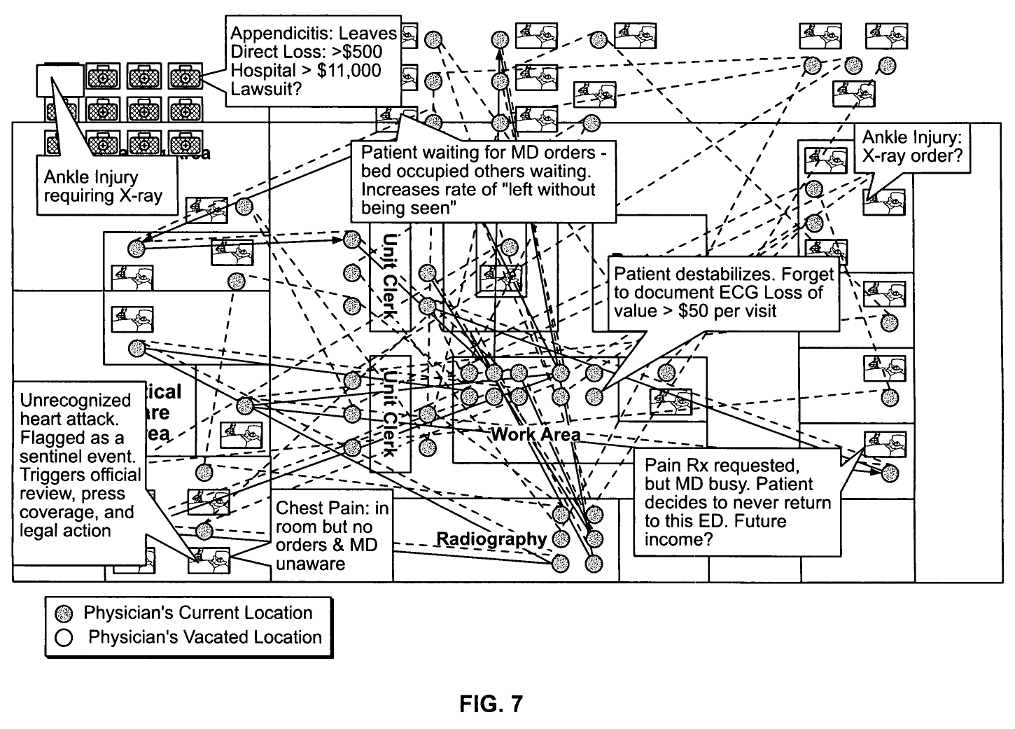

FIGS. 7, 8, and 9 provide various graphic representations of a complex workflow in an emergency department. FIG. 7 depicts an emergency room operating conventionally, without the inventive workflow management system, where several patients are being handled simultaneously over the course of several hours. Events are depicted in text boxes, and the paths associated with tasks and healthcare workers are represented by dashed lines. For example, A patient (1) arrives in the waiting room with an ankle injury requiring an x-ray, which is then ordered within the department after the patient has been waiting for 45 minutes. A patient (2) with appendicitis leaves the ED before being seen, thus representing a revenue loss as well as incurring a potential liability. In another part of the ED, a patient is brought in from critical care (3) waits for a bed that is occupied by a patient waiting to be discharged, putting that patient at risk for walking away. A heart patient (4) destabilizes, an ECG is run, but the service is not documented, incurring another loss. In still another corner of the ED, a patient (5) requests pain medication, but the physician nearby is too busy, and the patient leaves. In another corner of the ED, a patient (6) is undergoing chest pain, but it is unrecognized by staff. The event is later detected, flagged as a sentinel event, triggering review, press coverage, and legal inquiry.

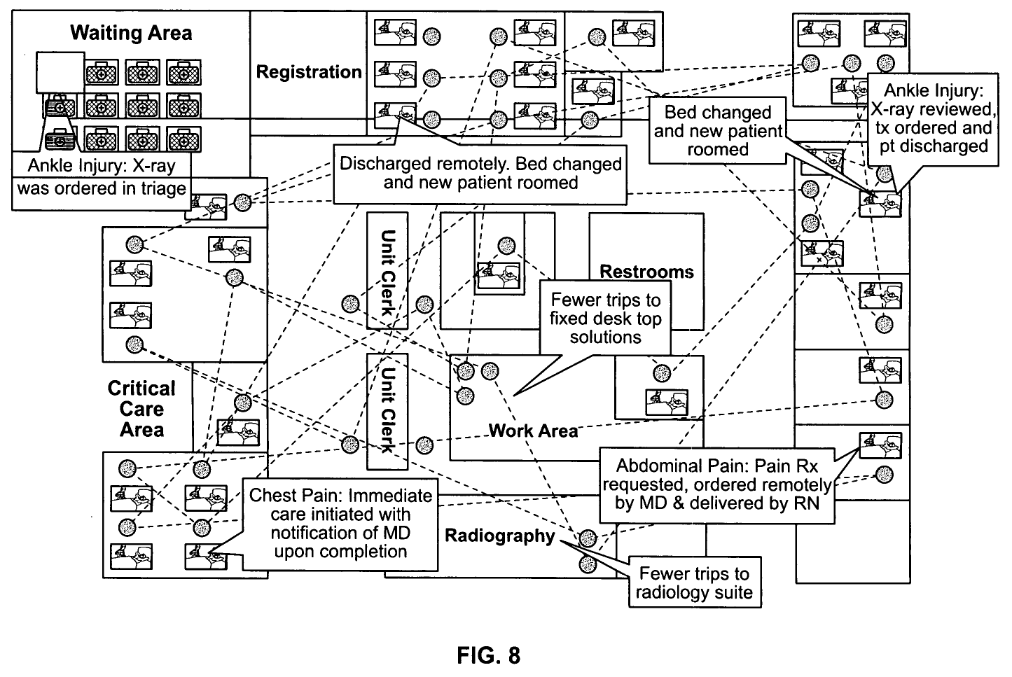

FIG. 8 represents the same emergency department, with the same complement of patients and staff, operating over the same time interval as that depicted in FIG. 7, but with an embodiment of the inventive workflow management system in place. A patient (1) arrives in the waiting room with an ankle injury requiring an x-ray, but the task has already been ordered at triage. The patient proceeds directly to x-ray, which is taken, reviewed, prescription ordered, and the patient discharged. A patient (2) with appendicitis arrives at the ED, is promptly seen and admitted to the hospital. A patient (3) from the critical care area is taken to an awaiting bed, from which the previous patient was remotely discharged 14 minutes ago. A heart patient (4) destabilizes, an ECG is run, the service is documented. In still another corner of the ED, a patient (5) requests pain medication for abdominal pain, the admitting physician, now in another part of the hospital, orders medication which is then brought to the patient by a nurse. In another corner of the ED, a patient (6) is undergoing chest pain, which is immediately recognized by staff, care is initiated by the team even before the admitting physician is notified. In general contrast to the ED operated as in FIG. 7, there are fewer trips by healthcare workers to computers at fixed desktop locations, and fewer trips to the radiology suite.

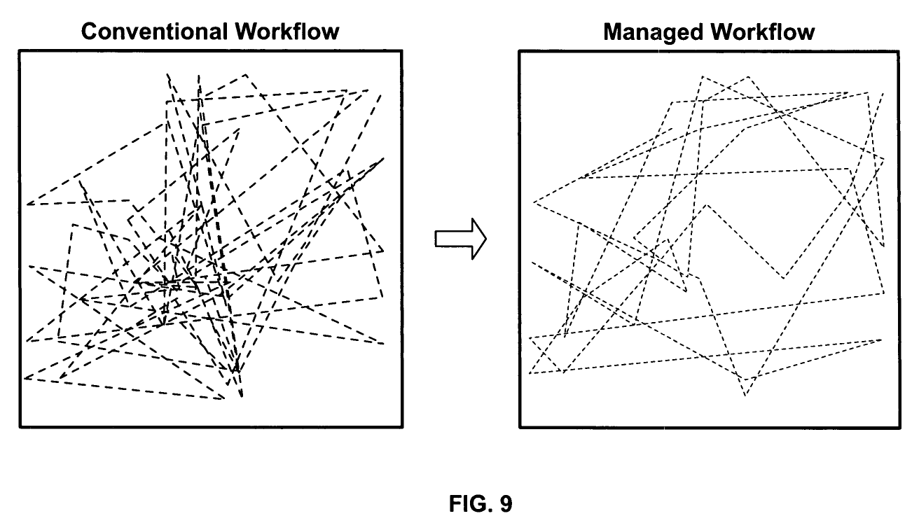

FIG. 9 schematically depicts the combined paths of patients, healthcare workers, and tasks in the conventionally operated ED as in FIG. 7 (on the left) and the same paths of the same patients, healthcare workers, and optimized tasks as in FIG. 8 (on the right). The effect, when reduced to this simple representation is quite plain. The same workload of patients and tasks is handled with significantly reduced traffic, and is further accompanied by favorable metrics such as decreased length of stay, higher quality of care, and reduced liability for the healthcare unit.

Architecture of the Workflow Management System

Core System Architecture

Event Framework Application (Including an Event and Message Transport Layer)

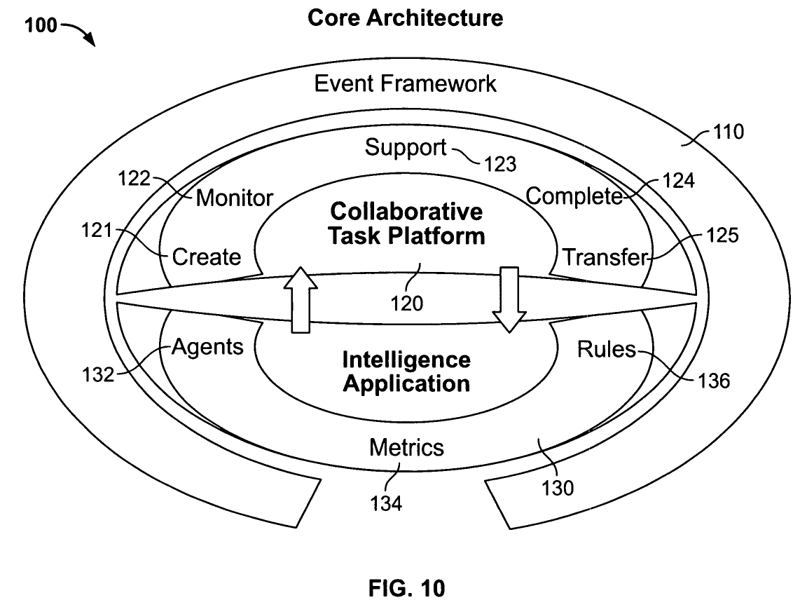

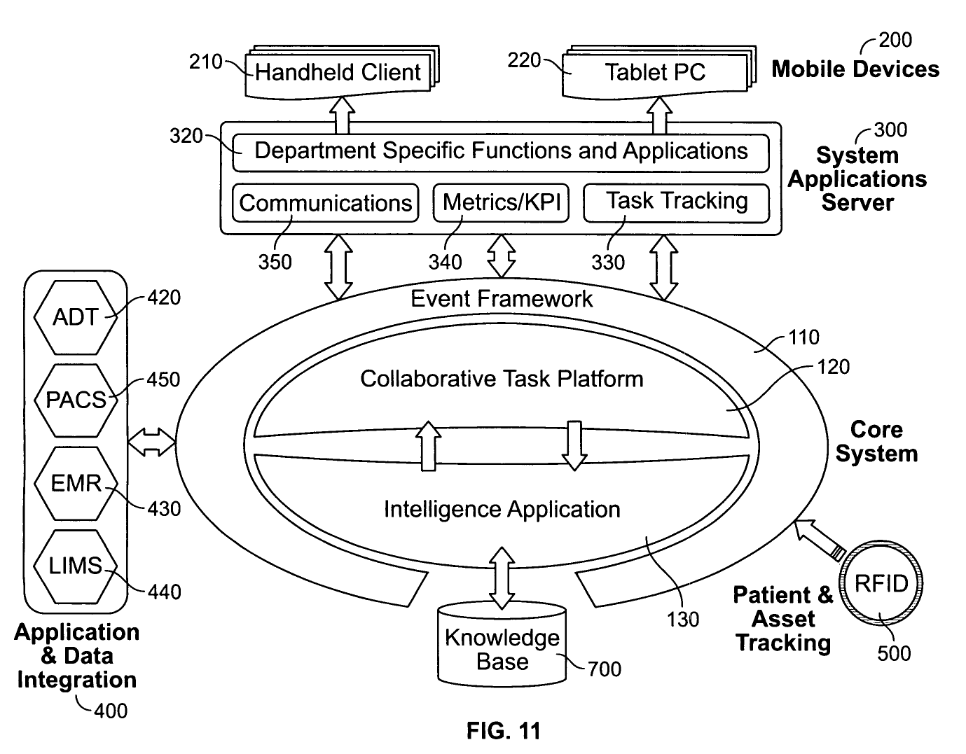

Embodiments of the invention include an event framework application 110 that communicates with other core system components such as the collaborative task platform 120 and the Intelligence application 130, as well as peripheral components, such as the system application server or task portal 300 and the integration server 400. The core system architecture is shown by itself in FIG. 10, and in conjunction with peripheral system components in FIG. 11.

Architectural component embodiments of the inventive system, both core and peripheral, typically make use of the best available open source-based operating systems and applications, such as, by way of example, Linux, Apache, JBoss, and Java. Embodiments of the invention also typically use open source standards for communication between components. Communication between clients and servers may be by way of a secure XML-based protocol. Communication between servers and third parties may make use of standards such as XML (Extensible Markup Language), HL7 (Health Level 7), DICOM (Digital Imaging and Communications in Medicine), JDBC (Java Database Connectivity), and ODBC (Open Database Connectivity). As they become mainstreamed, other Relational database management by embodiments of the invention may make use of MySQL (My Structured Query Language, for relational database management). Embodiments of the invention may further utilize “Mule” as an enterprise service messaging framework, and “Drools” as a forward-chaining rules engine. Embodiments of the invention, further, are compatible with any brand of client and server platforms.

Collaborative Task (or Workflow) Platform

Embodiments of the core system of invention include a Collaborative Task Platform 120 that communicates with the Intelligence Application 130 and Event Framework 110 of the core system, as depicted in the isolated context of the core system in FIG. 10, and in a larger context that includes the peripheral system components in FIG. 11. The collaborative task platform 120 hosts various task-related applications that create, monitor, support, complete, and transfer tasks within the healthcare unit, as have been described above.

Intelligence Application

Embodiments of the core system of the invention include an intelligence application 130 that communicates with the Collaborative Task Platform 120 and Event Framework 110 of the core system, as depicted in the isolated context of the core system in FIG. 10, and in a larger context that includes the peripheral system components in FIG. 11. The intelligence application 130 includes functional components such as agents 132, metrics 134, and rules 136.

Peripheral System Architecture Components

Clients: User Hardware

Embodiments of the peripheral architecture of the invention include client hardware devices 200, as depicted in FIG. 11, with which healthcare workers communicate to the system. Such client devices may include handheld devices 210 such as a personal digital assistant (PDA), a Tablet PC 220, a laptop computer 230, and a desktop computer 240 (for simplicity not all devices are shown). Embodiments of the invention may include keyboards and keyboard emulators for input devices as options for users as they prefer. Client hardware and software, as well as the adaptive user interface and icons of the invention, as described further below, are designed to provide access to and visibility of sought information within two taps or keystrokes. Embodiments of the invention include speech recognition for common commands, and voice transport to a dictation recognition service. Voice and video messaging and telephony may be enabled by VoIP (voice over internet protocol). Some embodiments of client user devices include still camera and video capability as well as enabling applications for sending and receiving same. Some embodiments of client user devices include a pager and instant message capability as well.

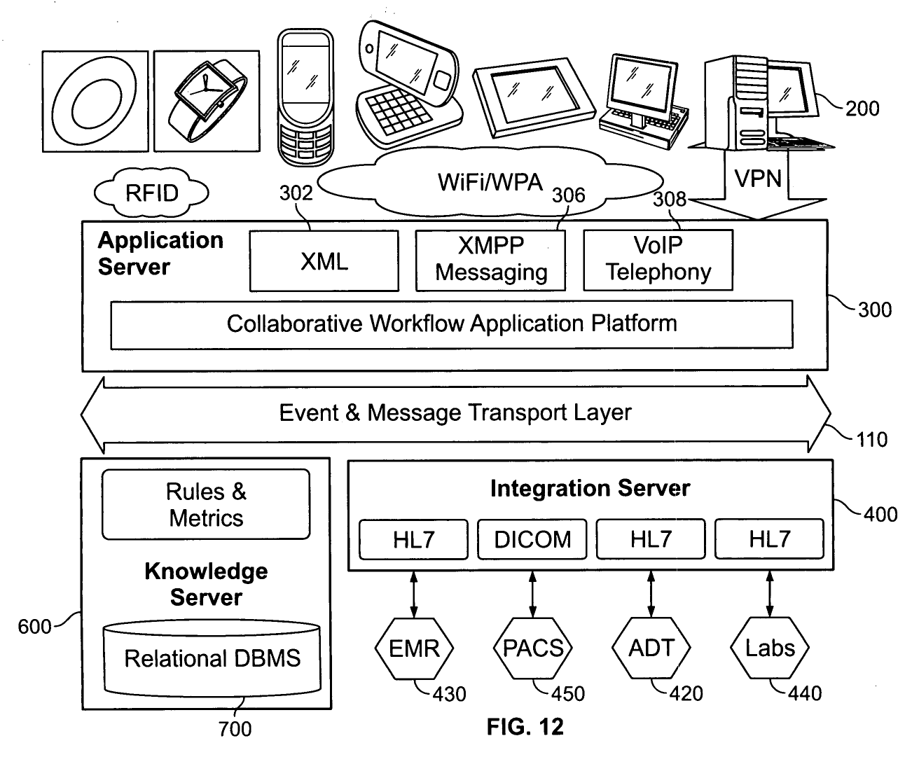

These client devices or computers communicate with the system applications via the application server 300. This communication may occur by both direct wire connections, or via wireless connections, as for example by way of WiFi/WPA (wireless protected access), VPN (virtual private network), and RFID for locational data. The client hardware devices 200 are also shown in FIG. 12, in a context that is centered on the event and message layer 110 of the core system architecture 100. This figure represents the event and message layer 110 as the major interface between the core and peripheral systems, as well as between the system as a whole, within the context of the healthcare unit and the outside world.

System Applications Server

Embodiments of the peripheral architecture of the invention include a systems applications server or task portal 300, which communicates with the user hardware devices 200 and the event framework 110 of the core system 100, as depicted in FIG. 11. The applications server 300 can host a number of enabling applications, including AJAX (Asynchronous JavaScript and XML) presentation 302, JSP (Java stored procedure) logic 304, XMPP (Extensible Messaging and Presence Protocol) messaging 306, and VoIP (Voice over Internet Protocol) telephony 308. The system applications server 300 further can host a number of functional applications including department-specific applications 320, task manager or task tracker 330, reporting analytics or metrics/key performance indicators (KP)I 340, and a documentation or communications manager 350. An aspect of one embodiment of the systems applications server 300 is also shown in FIG. 12, in a context that is centered on the event and message layer 110 of the core system architecture 100.

Integration Server

Embodiments of the peripheral architecture of the invention include an integration server 400 that communicates with the legacy applications (by way of various servers 410) and the Event Framework 110, as depicted in the broad context of core and peripheral component of the system in FIG. 11. An aspect of an embodiment of the integration server is also depicted in FIG. 12, which emphasizes its interaction with the event framework 110 of the core system 100. Any number of legacy applications and servers may be connected to the integration server. These applications generally conform to various respective industrial standards, such as “Health Level 7” (HL7) and “Digital Imaging and Communications in Medicine” (DICOM). Thus, the following HL7-type applications may be included: ADT (Abstract Data Type) 420, EMR (Electronic Medical Record) 430, LIMS (Laboratory Information Systems) 440. DICOM-based applicatins include PACS (Picture Archiving & Communication Systems) 450.

Patient and Asset Tracking RFID Tags

Embodiments of the of the peripheral architecture of the invention include patient- and healthcare unit asset-tracking radio frequency identification (RFID) tags 500 that communicate with the event framework application 110, as depicted in FIGS. 11 and 12. The locational data attached to people and items can be vitally important in optimizing workflow from various perspectives, including the time and energy consumed in movement of people, which is an aspect of the task management example 3, described above, and as depicted in FIGS. 7, 8, and 9.

Database Server and Knowledge Base

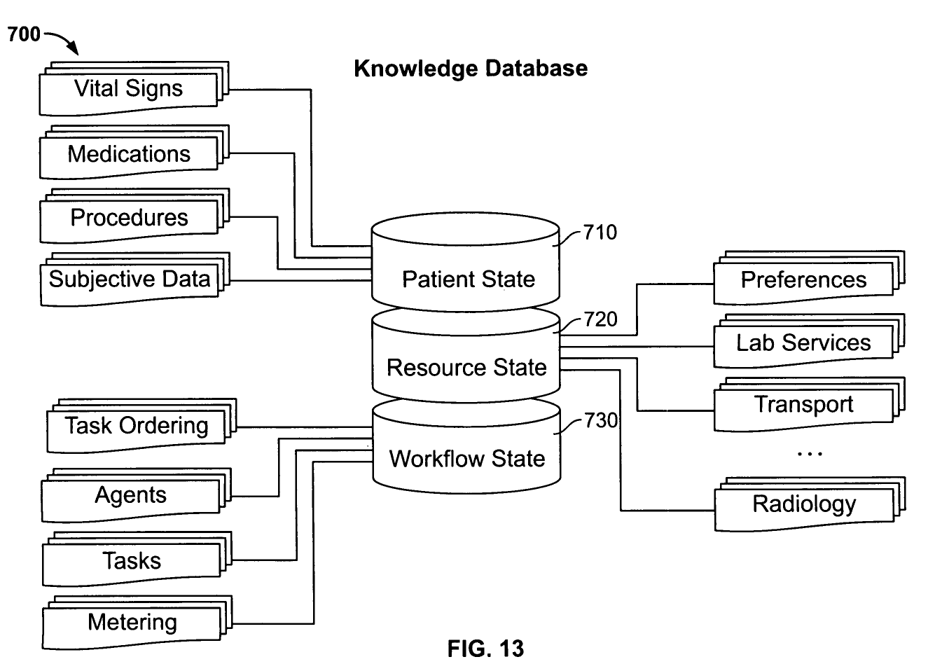

Embodiments of the peripheral architecture of the invention include a database- or knowledge server 600 that communicates with the Knowledge Database 700 and the Event Framework 110 of the core system 100, as shown in FIGS. 11 and 12. The types of data that the system can obtain from knowledge database(s), through the database server 600, is depicted in FIG. 13, and includes (1) the patient state (for example, vital signs, medications, procedures, and subjective data), (2) the resource state (with regard to, for example, preferences, lab services, transport, and department specifics), and (3) the workflow state (for example, task queing, agents, tasks, and metering). The system has the capability to access and query multiple databases simultaneously.

An Adaptive User Interface

Overview

Conventional user interfaces (UI) commonly available or assigned to physicians are of a generic one-size-fits-all configuration that presumes a work style commonality that does not actually exist, and requires a regimented behavior. Understandably, physicians do not take to these user interfaces, and the systems tend to fail in the market. The variety, specificity, and complexity of different specialties and different types of healthcare units creates the need for a UI that is flexible and customizable. For one thing, the act of medical decision making is very complex.

Information needs for physicians can vary greatly, the following scheme classifies these differences in four ways simply for the purpose of illustration:
1. Field of Specialty: Physicians train differently for various specialties and that training reflects differences in approaches to patient care and to information needed. For example, an ED (emergency department) physician's information needs will differ significantly from those of a family practice physician. The ED physician's role is immediate stabilization of the patient while that of the FP physician is long-term treatment.
2. Experience and Level of Expertise: Younger or less experienced physicians tend to be very detail-oriented in their approach to patients because of the fear of missing important information. Veteran physicians, based on their individual experience, tend to look for certain “nuggets” of information that help them quickly guide diagnosis and treatment.
3. Medical Context: A physician working in a clinic will have different information needs than if the same physician is working in the ED. In addition, the same patient seen in the ED may receive different care and draw on different resources if alternatively—or later seen in a clinic for the same medical problem.
4. Technology Comfort Level: A physician who is comfortable with technology will have the ability to handle more complex interfaces than someone who is uncomfortable with technology.

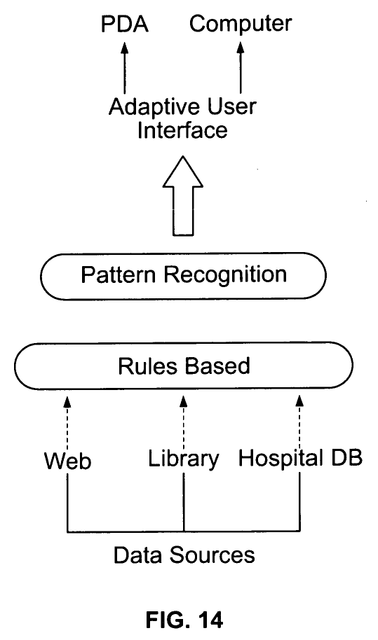

A novel approach to creating an adaptive user interface is described below is outlined in FIG. 14, and expanded upon below in sections describing data sources, rules, patterns, and artificial intelligence.

Data Sources

Data for the inventive adaptive user interface (AUI) can be amassed from at least three types of main sources. The Worldwide Web typically serves as a first source, and initially a user may actively choose a selected set websites (5 to 10, for example) that can feed into the AUI. The inventive AUI can use a semantic web approach whereby the AUI can actively scan the entirety of World Wide Web for relevant information based on a set of specific criteria. Second, hospitals generally have access to proprietary databases (e.g., Medline) that can be subscribed to through the hospital library. Third, the hospital database that holds patient information in the form of an EMR or equivalent. Other data sources not listed here can also be placed into the system. Embodiments of the inventive task management system and the AUI may index or integrate into other technologies (e.g., semantic web technology) to make search and customization much easier.

Rules-Based

Based on a set of constraints embodiments of the invention provide a generic UI for a specific specialty of physicians (e.g., emergency medicine). For example, the top 20 diagnoses in EDs across the United States of American show a high degree of identity. For example, heart attacks, pneumonia, broken bones are examples of common diagnoses across most if not all EDs. The data needs for a physician seeing a heart attack patient, for example, can be standardized. In this case, most ED physicians will want to know data such as past medical history, last EKG, allergies, age, history of a heart attack, risk factors, medications, chest x-ray, and results of a stress test. Similarly, embodiments of the invention can do the same for other diagnoses. Thus, based on these diagnostic data and other constraints (e.g., guidelines of care for specific diagnoses from the NIH) embodiments of the invention provide a generic UI, tailored to sets of users, as defined by market needs. Data for a specific type of patient populate the UI based on the symptoms that the patient gives to the triage nurse when entering the emergency department. Other such constraints to help refine this generic UI can also be obtained by studying the medical literature. For example, if a often-used lab marker for a disease is called into question, the generic UI can reflect that change for such patients. In this manner, one can create a generic UI that keeps up to date with the changing medical landscape.

Patterns

The inventive UI can allow and encourage physicians to drill down into further detail by clicking onto topics from the data sources. For example, Physician A may want to know more about specific data in pulmonary medicine. Over time, he or she will continue to search for pulmonary medicine data that is available from the data sources. The system then picks up these patterns for Physician A and then changes the UI to automatically present such information the next time he logs onto the system. Physician B may want to know more about costs of drugs for patients who come in with chest pain, and this pattern will also be recognizable. Again, the UI will modify itself to reflect that need. It is important to note that if a physician stops interacting with certain information that he was previously interested in, that information drops in priority scoring and is not presented as core data in the UI. The user, however, can actively choose to keep certain topics on the UI.

Similar pattern recognitions can also be analyzed for any data entry the user initiates (e.g., documentation on patients for billing). Physicians typically have habits that serve them well in their practice. For example, physicians typically go to a set of favorite” orders or sets of orders, or “favorite” prescriptions. A physician tends to have a certain way of documenting each patient visit type (for example, a heart attack), and the UI will learn to reflect that pattern the next time a similar patient arrives. So the next time the physician is about to document a patient with a heart attack, the inventive task management system can recognize the presenting medical circumstance as consistent with a previous pattern, and bring up what was done in the previous 3-5 cases of heart attacks. This pattern recognition capability minimizes the user need to enter data and hastens workflow.

Artificial Intelligence

In some embodiments of the invention, other complex artificial intelligence (AI) technologies are brought into the system once a baseline of pattern recognition data is collected on individuals. The inventive system then offers new data based on old patterns. Because the UI is tailored to the individual at this point in time, the user is very comfortable with navigation, and recognizes any new data added to the UI. This phenomenon is important in the need to modify or evolve physician behavior toward the end of improving outcomes. One aspect of embodiments of the system is the targeting of new information to a user (in this case, a physician) under appropriate (and only appropriate—) circumstances, appropriate with regard to the patient, the healthcare setting, and the physician's receptivity or need-to-know status with regard to such information.

PDA/Computer

User interface information, as provided by embodiments of this invention, may be displayed on any of a variety of mobile devices, including personal digital assistants (PDAs), laptops, tablets, as well as on a desktop computer interface. Mobile devices are typically able to display subsets of available data, generally high-priority data, high-use, and/or distilled data (i.e., graphs), and they allow users the ability to act on such data (i.e., write orders on patients). Data output can also vary based on the capabilities and appropriate use of the client device. The desktop computer interface typically accommodates the full capability of the adaptive user interface (AUI). Embodiments of the invention provide for intermediate size data subsets for laptops and tablets. The PDA, for example, is mobile but in its present state of development, may be impractical to use as a primary device to enter data.

Within the UI, users may search for relevant information in the context of a specific patient (e.g., more information about new drugs for a specific patient with a heart attack) or may do general queries on topics of interest that may not be associated with a specific patient (e.g., new guidelines on hypertension and the associated medical literature). Other features, such secure e-mail by way of example, may also be added to create even more depth to the AUI. The importance of developing this AUI is in improving workflow for physicians. With this approach the technology molds to the physician, making it much easier for him or her to complete tasks at hand. This approach can easily be generalized to all physicians and to other professions with complex decision-making requirements.

Applications on the client user devices, in embodiments of the invention, are typically task-oriented and are characterized by glance-and-go simplicity. Data input and output are multimedia in nature (text, images, video, audio, voice, etc.). The applications are easily configurable to suit the preferences of the user, and communication to other components within the system is secure.

### ADAPTIVE USER INTERFACE EXAMPLE 1

### Functionality

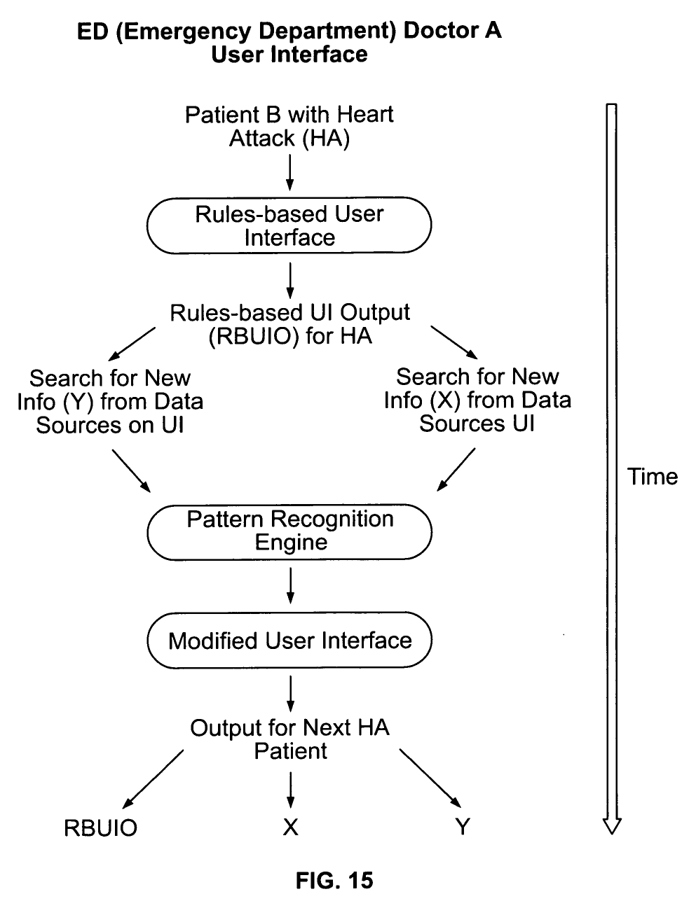

What follows is a simplified description of the functionality of the adaptive user interface, embodiments of the invention are capable of far more complex function. FIG. 15 depicts a process that may follow the entry of a heart attack patient into an emergency department, and which is described below.
1. Patient B, while in the midst a heart attack, appears at the emergency department; the physician's user interface (UI) automatically pulls up a set of standard data based on rules (thus, “rules-based user interface output”, or RBUIO). This data set may include information on the patient's past medical history, including, merely by way of example, medications, allergies, risk factors, last chest x-ray, and the last EKG.
2. The physician who sees this patient, however, knows (or comes to know) that the patient has other illnesses that may complicate treatment (e.g., the patient has advanced diabetes and has allergies to a commonly used drug that is used to treat heart attacks). The physician thus initiates a search on the user interface either by browsing generalized topics on the screen (e.g., diabetes), or by typing a query that summons topics of interest.
3. New information Y is data on alternatives to the drug to which the patient is allergic, and the physician quickly reads about side effects, common interactions, and dosing.
4. New information X is data about a new paper in a medical journal that is relevant to this patient, but the physician does not immediately have the time to read it. Accordingly, the physician clicks a button to download the paper into his or her customized UI folder to read later.
5. The pattern recognition engine of embodiments of the inventive task management system recognizes at least two things. First, it recognizes the type of patient that was seen by the physician (using factors such as age, chief complaint, final diagnosis, tests done) and the search that was done by the physician in relationship to that patient. This recognition can be done automatically after the physician follows a specific pattern multiple times, or may be initiated immediately by the physician who wants certain types of information presented to him for all similar patients or for all patients in general (e.g., costs of drugs). The UI then integrates those patterns into a distilled format that makes it easier the next time such a patient visits this physician.
   Pattern recognition can occur within the context of specific types of patients, meaning that information can be presented only when a specific type of patient is looked at, or it can be generalized to include such information throughout the interface (e.g., a physician may be interested in keeping up to date with pulmonary medicine or with new drugs for a certain type of disease). The way to integrate information into the UI is to consider how such information can improve workflow or outcomes. Further modifications may be effected: data from a specific website/source can be put into a distilled format by using semantic web technology. For example, drug information can be gathered from all pharmaceutical company websites and placed in one easily accessible and updated database.
6. The next time a patient with a heart attack comes in with similar medical complexities, the newly modified UI presents the standard information (RBUIO), and new information X, and new information Y at the beginning of the patient visit.
7. Physician behavior may be influenced through the use of the AUI. Once the inventive system has adapted to an individual, it can present new data (for example, a new drug that is now considered a gold standard of care for a specific disease) in the context that that individual physician is ready to accept such information. In other words, embodiments of the inventive system speak to users in an individualized event- and task-appropriate manner.

Based on the ability of embodiments of the inventive task management system to recognize user behavioral patterns, the system learns that one physician typically wants to see new information after his shift is complete in the emergency department; while another physician is typically more open to new ideas when he is at home and has time to read about new interventions. This feature of the task management system offers the benefit of providing an approach for influencing and training physicians to perform at higher levels of professional performance by virtue of its ability to turn pattern recognition into activation of features in a contextually appropriate manner, and thereby supporting and enhancing individual learning habits. Such benefits do not accrue from conventional workflow management solutions, which tend to force users to mold to them, rather than the application molding to the user. This aspect of the invention has important implications as it takes an average almost two decades for new medical evidence to be broadly applied in general medical practice. The inventive task management system thus may accelerate the evolution of medical practice in desirable directions, and may be able to significantly reduce individual learning curves, as well as have an effect on the rate of implementation of improved medical practice within the medical community as a whole.

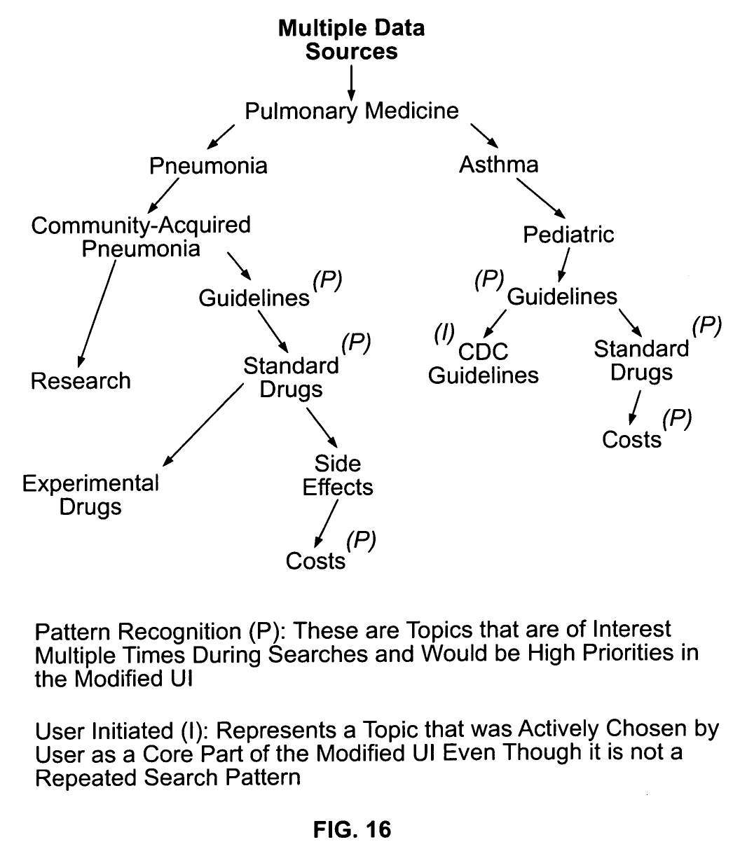

A further description of a sample search pattern (and recognition) that may be carried out by an embodiment of the invention is shown in FIG. 16. The diagram represents two searches through the general topic of pulmonary medicine. In one search, pneumonia was the topic and in the other asthma was the target. The arrows delineate the path of search for sub-topics under the general disease heading. The notations of (P) represent patterns that are common to both searches and are likely topics of general interest to the user. These have a much higher chance of being topics that are of high priority as the UI modifies itself to mold to user needs. The notation of (I) represents a topic, i.e., Center for Disease Control (CDC) guidelines, that are of specific interest to that user. The user can actively decide to make that topic a core part of his modified UI. This diagram represents a simple model of how this pattern recognition would work in this invention. Other types of pattern recognition and user-initiated choices not overtly delineated here would be included as a part of this invention.

The importance of this AUI is in allowing technology to mold to physician needs. Thus far, there has been no easy way to create an interface that can model the complex decision making process physicians follow. Furthermore, each physician has his or her own way to taking care of patients, and there may be more than one way to treat the same patient. These complexities have made it hard for other technology to be accepted by physicians. With this invention the need to model that complex decision making process is removed because the invention allows the individual to mold the UI to fit their own specific needs. Importantly, the UI can mold itself to that individual physician even as he changes or learns new ways to treat patients. It will easily improve individual workflow, minimize information overload, and potentially have a large scale impact on the quality of care provided by making important information easily accessible and usable.

### ADAPTIVE USER INTERFACE EXAMPLE 2

### Optimizing the Visual Space

Another aspect of the functionality of the adaptive user interface involves the functional combination of the task sorting and filtering capabilities with optimizing the constraints of the visual interactive space offered by the users' client hardware devices (as described above). The most constrained visual space is typically that offered by the most mobile of devices, a handheld personal digital assistant (PDA). The visual space of the PDA is small, thus embodiments of the invention provide for the display of important information within a single screen, and without the necessity of scrolling down a screen below the portion that is immediately visible, or by flipping forward to follow-on screens.

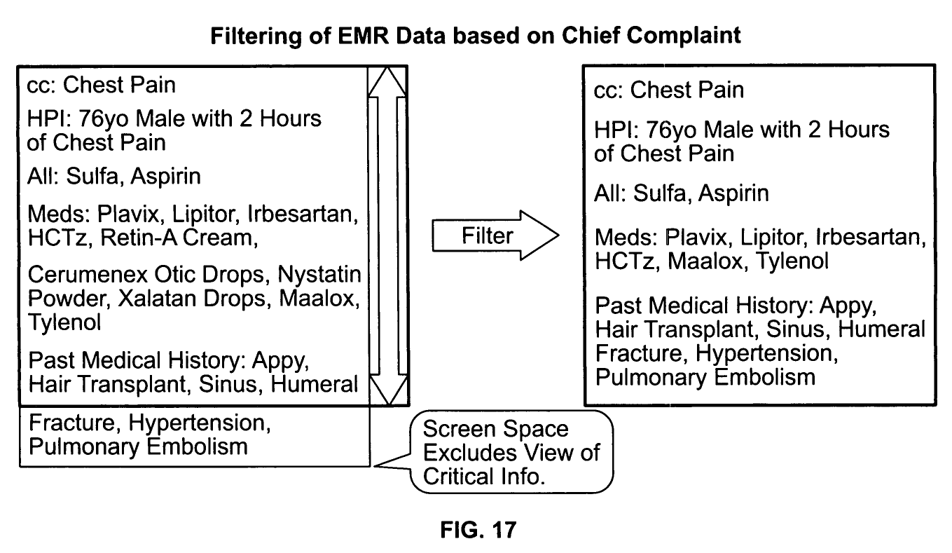

FIG. 17 depicts a representation of two screen shots of data as they may be displayed on a PDA screen. On the left is a screen shot of a non-optimized, conventional system, and on the right is a screen shot generated by the inventive system, enabled by filtering and sorting, and enabled by an adaptive user interface. It can be seen that the non-optimized screen projects a full complement of data pertaining to the individual patient, a 76 year old male who has been experiencing chest pain for two hours, but some information is below the visible screen and would require scrolling to expose to view. On the right, is the optimized screen; in part it is the same, and in part it's truncated. What is absent from the screen are data that are not immediately relevant to the chief complaint of the patient. Thus conserved by this feature is the cognitive space of the user, who is not distracted by information irrelevant to a “chief complaint”, for example; also conserved is the time required for visual scanning and physical manipulation of the handheld device. These principles of conserving cognitive and visual space, informed by principles taught by Edward Tufte (see references and further elaboration in the description of the user interface icon, below) are exemplified by screen displays throughout embodiments of the invention, particularly in embodiments that include the PDA as a user device for engaging the inventive workflow management system.

Software User Interface Icon to Monitor Patient Flow in Healthcare Settings

Healthcare settings have a constant need to monitor patients and their flow within the hospital—primarily to provide efficient delivery of care. Hospitals and other healthcare settings are typically paid a lump sum of money to provide services per patient. Within that business model, it is in the hospital's interest to provide quick and efficient care in order to maximize revenue by bringing in more patients. However, this flow of patients through hospitals and other healthcare settings is highly inefficient, partly because of the large dispersed team that is involved in the process of treating patients. Other problems include the lack of information regarding where the patient is within the treatment process. Also, key decision makers like physicians do not have data available that will allow them the ability to make a decision and move the patient along within the process.

In making these decisions providers (e.g., physicians, nurses) understand that all information is not necessary in order to create efficiencies. Certain data take priority over other data. These decision-level data are quite standardized and are not based on individual providers. For example, to find out if a patient has had a heart attack one can find out using an electrocardiogram or use a lab test (i.e., troponin levels). Most physicians will prioritize these two pieces of data as more important than patient data regarding immunizations, for example. This is all based on acuity and certain pieces of data being more relevant and more important than other data.

The flow of patients through the healthcare setting is typically based on getting quick access to such data. A patient may be kept in a hospital an extra day, for example, because the physician does not want to release the patient until he has had a specific test that cannot be done today (e.g., the technician went home). Tracking these kinds of deliverables for physicians has become difficult. Most physicians are unable to keep track of all the tasks in an efficient manner. Second, although tasks may have been completed for a specific patient, the physician is often unaware because of poor communication of the results from the task. This prevents the timely flow of the patient to the next required task or worse, it prevents the patient from being discharged from the healthcare unit.

The inventive task management system provides a solution to this problem that providers face, namely an inability to track patients through the care process. To do so, the invention provides a software icon available for providers on any graphical user interface (e.g., handheld, PC, tablet, desktop computer). The design of the icon, as well as the encompassing adaptive user interface are informed by the principles exemplified by the work of Edward Tufte (“Envisioning Information”, Graphics Press 1990, ISBN 0961392118; “The Visual Display of Quantitative Information”, Graphics Press, 2^{nd} edition, 2001, ISBN 0961392142; “Graphical Summary of Patient Status” by Powsner and Tufte, Lancet vol. 344, p 386-388, 1994; “Summarizing Clinical Psychiatric Data”, by Powsner and Tufte, Psychiatric Services vol 48, 1458-1461, 1997) which collectively emphasize highly efficient visual communication of information. The efficiency and effectiveness of the visual communication within the inventive icon and user interface manifests as (1) high volume of information delivered per unit of graphic space, as well as (2) high information content delivered per unit time of visualization and comprehension of such information.

Accordingly, the inventive workflow management system provides intuitive graphical icons for discrete healthcare related information; examples include patient status and vital sign data, prescriptions, test, and procedures, notes (written, dictated, images), and patient location. The icons, being intuitive and representing large amounts of information in the Tufte style (as above) require a minimal learning curve for the user. The icons of the present invention, more specifically, have certain characteristics, which for purpose of description are delineated as four aspects, as described below:
1. Real-time Updateability: The icon updates available information about completion of tasks in a real-time manner.
2. Visual Features: The icon heavily depends on using color and graphs to display key pieces of data. For example, a flashing icon would mean a task is completed or the viewer has a message associated with a patient flow task.
3. Granularity of Data: The icon would use visual display of certain important data at a very high level. For example, a yellow color may mean that certain tasks are pending; a green color may mean that all tasks are completed. Graphs and other visual methods would be utilized to show very high level data that is relevant to patient flow.
4. Layering of Data: The user may use the icon to find out more information related to a specific task. If the user, for example, places a stylus on an area of the icon that is showing where the patient is, the user can get more details about how long the patient has been in that area (e.g., radiology department) or get an idea of total length of stay in the hospital. Deeper layers can be accessed by touching the icon to open up another layer of data. For example, data about how long the patient spent in different areas of the hospital can be accessed in order to find out where the bottlenecks are.

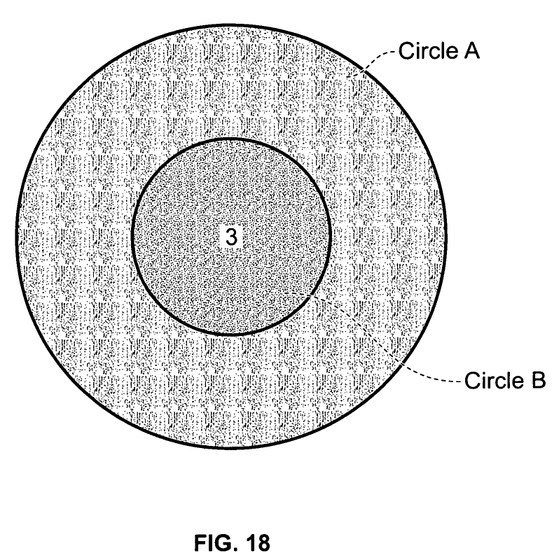

FIG. 18 represents an exemplary version of how the data can be presented to assess patient flow within a healthcare setting. Many other versions are possible; what is important is how data is prioritized in a visual format to allow users to quickly assess where the patient flow is for an individual patient. A specific icon would be created for each patient and be represented on a user interface (e.g., handheld or PC).

The outer Circle A (FIG. 18) represents the orders or tasks that are being carried out by the rest of the team within the healthcare setting (e.g., nurse drawing blood for lab tests). It is color coded to display completion of tasks. For example, a patient may need to have a chest x-ray and lab tests completed before the physician has the ability to make decisions for that patient. Those two tasks are subsumed in Circle A, and when they are both completed the outer circle may turn green. In this case it is yellow and at least one of those tasks is not completed. Variations of this theme can be created by prioritizing tasks. Part of Circle A (closer to Circle B) may represent more important tasks that need to be completed and less important tasks can be represented on the outside parts of the circle. One can also add other features such as a flashing Circle—in that case it may mean that there are specific results that need attention or that the physician has not looked at new results of lab tests that have been completed.

A click (using a stylus or cursor) on the circle can bring up more details of which tasks are completed and which ones are pending, when the task was ordered, and the ability to get in touch with the person who needs to complete that task (using the phone on a PDA or by instant messaging). More details of tasks can be accessed at the next layer down: the time between ordering a task and completion time, and who is currently responsible for the task etc.

The inner Circle B (FIG. 18) represents other visually-coded data. The number in the middle of the circle represents acuity (i.e., how severe the patient's illness is) and the user can easily gauge how quickly he will need to react to this patient. The color of the circle can represent where the patient is physically located. For example, if the circle is blue it may mean that he is in his patient room; if it is yellow it may mean he is in the waiting room yet to be seen by anyone. Red may mean the patient is missing or cannot be found. This data of physical location of patients can be assessed using radio frequency identification (RFID) technology; typically, for example, the patient wears a wrist band that can be detected by RFID readers.

More details can be obtained by using a stylus (or cursor) to tap the inner circle. Data that can be obtained includes but not limited to where the patient physically spent the longest time period, the ability to change acuity number, contact the team-member who is the closest to the patient physically, etc.

Other features or connections can be made. Through device gateways, equipment like emergency department monitors can be connected to the icon in order to track vital signs. If the vital signs do not stay in a normal range, then the icon can flash red and emit an associated beep to alert the physician. Also, users can actively choose what granular data they would like to add to the icon. One physician may always want to know if any lab results are abnormal, while others may want to continuously monitor other patient parameters (e.g., vital signs, or an assessment from a specialist). Ultimately, the purpose of this real-time patient flow icon is to hasten the process by updating individual users about patient status in a structured manner (i.e., data is prioritized and presented in a visual format rather than quantitative format at the top layer; deeper layers expand on details of the data).

The flow of patients within healthcare settings is typically very inefficient and hospitals have financial and clinical (i.e., patient safety) motivations to make that flow a very efficient process. The software icon represented above takes into account that flow needs to be streamlined and represents the flow data in a prioritized visual format. The goal is to create a layering of relevant data so that decision-makers (e.g., physicians, nurses) have the ability to make decisions that have a positive impact on patient flow through the healthcare setting. Currently there is no consolidated mechanism where decision-makers have access to such key data. Second, the data does not need to be represented in a detailed format right away (e.g., details of a lab test that are normal), but rather can be very granular initially (e.g., whether the test is abnormal or normal). This can allow quick decisions about flow, and if the user so chooses he can then easily access more detailed data (e.g., he needs detailed lab data to do patient documentation later) in an easy to use manner. Much of this granular data can be represented visually.

This icon is relevant to all healthcare settings where patients have to undergo individual or multiple tests or procedures in order to finish treatment. It can be used in a setting with a shorter time frame for treatment (e.g., within the emergency department where one only stays a few hours) to a much longer time horizon (e.g., in an outpatient clinic where the time span for treatment process can take months to years). It can also be tailored specifically for different types of healthcare settings. For example, the icon can be used in the emergency room and the icon would represent specific common tasks associated with the emergency department. If used in the outpatient clinic the tasks the circle represents would be different. A core value of the invention is to allow the ability to prioritize data and represent it in a granular format (e.g., visual data) in order to enhance patient flow significantly.

Equivalents of the Invention

While particular embodiments of the invention and variations thereof have been described in detail, other modifications and methods of using the disclosed workflow management system will be apparent to those of skill in the art. Accordingly, it should be understood that various applications, modifications, and substitutions may be made of equivalents without departing from the spirit of the invention or the scope of the claims. Various terms have been used in the description to convey an understanding of the invention; it will be understood that the meaning of these various terms extends to common linguistic or grammatical variations or forms thereof. It will also be understood that when terminology referring, for example to hardware, software, or therapeutic agents has used trade names or common names, that these names are provided as contemporary examples, and the invention is not limited by such literal scope. Terminology that is introduced at a later date that may be reasonably understood as a derivative of a contemporary term or designating of a subset of objects embraced by a contemporary term will be understood as having been described by the now contemporary terminology. Further, it should be understood that the invention is not limited to the embodiments that have been set forth for purposes of exemplification, but is to be defined only by a fair reading of the appended claims, including the full range of equivalency to which each element thereof is entitled.

What is claimed is:

1. A system for managing workflow comprising:
a core system architecture comprising:
an event framework application,
a collaborative task platform, in communication with the event framework application, and
an intelligence application, in communication with the event framework application, and
a peripheral system architecture comprising:
one or more client devices,
a system applications server in communication with the one or more client devices and the event framework application,
an integration server in communication with one or more legacy applications and the event framework application,
a plurality of locational tracking tags in communication with the event framework application,
a database server in communication with the event framework application, and
one or more knowledge bases in communication with the database server.

2. The system of claim 1 wherein the workflow occurs within a healthcare unit.

3. The system of claim 1 wherein the event framework application comprises an event and message transport layer.

4. The system of claim 1 wherein the collaborative task platform comprises functions that create, monitor, support, complete, and transfer tasks.

5. The system of claim 1 wherein the intelligence application comprises functional components agents, metrics, and rules.

6. The system of claim 1 wherein the one or more client devices are selected from the group consisting of handheld PDAs, tablet PC, laptop computer, and desktop computer.

7. The system of claim 1 wherein the systems applications server comprises one or applications selected from the group consisting of AJAX, JSP, XMPP, and VoIP.

8. The system of claim 1 wherein the systems applications server comprises one of more applications selected from the group consisting of department specific applications, task manager, reporting analytics, and documentation manager.

9. The system of claim 1 wherein the legacy applications in communication with the integration server comprise one or more of the applications selected from the group consisting of ADT, EMR, LIMS, and PACS.

10. The system of claim 1 wherein the locational tracking tags comprise RFID chips, the RFID chips being associated with users, equipment, and material within a healthcare unit.

11. The system of claim 1 wherein the databases in communication with the database sever comprise one or more types of data selected from the group consisting of patient state data, resource state data, and work flow state data.

12. The system of claim 11 wherein the patient state data include one or more types of data selected from the group consisting of vital signs, medications, procedures, and subjective data.

13. The system of claim 11 wherein the resource data include one or more types of data selected from the group consisting of user preferences, laboratory services, transport data, and department data.

14. The system of claim 11 wherein the workflow data include one or more types of data selected from the group consisting of task queing, task filtering, task sorting, agents, tasks, and metering.

15. A method for managing workflow in a healthcare unit comprising:
entering data into one or more client devices, the devices being integrated into a workflow management system comprising:
a core system architecture comprising:
an event framework application,
a collaborative task platform, in communication with the event framework application, and
an intelligence application, in communication with the event framework application, and
a peripheral system architecture comprising:
the one or more client devices,
a system applications server in communication with the one or more client devices and the event framework application,
an integration server in communication with one or more legacy applications and the event framework application,
a plurality of locational tracking tags in communication with the event framework application,
a database server in communication with the event framework application, and
one or more knowledge bases in communication with the database server.

16. The method of claim 15 wherein entering data comprises managing a task.

17. The method of claim 16 wherein managing a task comprises one or more steps selected from the group consisting of:
defining a task, the task comprising one or more subtasks,
initiating the task,
monitoring the task,
modifying the task,
sharing the task, and
completing the task.

18. The method claim 17 wherein the task being defined is an unstructured task.

19. The method of claim 15 wherein entering data comprises managing multiple tasks, the aggregate multiple tasks comprising a workflow.

20. The method of claim 19 wherein managing a workflow results in a more efficient workflow, the more efficient workflow being demonstrable by an increased return on investment.

21. The method of claim 20 wherein the increased return on investment relates to a shorter length of stay by a patient in a healthcare unit.

22. The method of claim 20 wherein the increased return on investment relates to a decrease in errors in a healthcare unit.

23. The method of claim 20 wherein the increased return on investment relates to an increase in revenue for the healthcare unit.

24. The method of claim 15 further comprising creating a task-based process map, the process map providing a context for managing one or more tasks.

25. The method of claim 24 wherein managing one or more tasks comprises one or more of the steps:
defining a task, the task comprising one or more subtasks,
initiating the task,
monitoring the task,
modifying the task,
sharing the task, and
completing the task.
